(19) United States
(12) Patent Application Publication
(10) Pub. No.: US 2018/0260858 A9
(43) Pub. Date: Sep. 13, 2018

(54) System and Method of Payment for Online Content with Adaptive Value Calculator

(71) Applicant: RedGage LLC, Miami Beach, FL (US)

(72) Inventor: Daniel Redlich, Miami Beach, FL (US)

(21) Appl. No.: 14/065,841

(22) Filed: Oct. 29, 2013

Related U.S. Application Data
(63) Continuation-in-part of application No. 12/274,668, filed on Nov. 20, 2008.

(51) Int. Cl. G06Q 30/02; G06Q 20/14

(52) U.S. Cl. CPC G06Q 30/0273; G06Q 20/14

(57) ABSTRACT

The invention calculates, allocates and pays a Content-Provider-CP for online content with an adaptive value calculator, a payment processor computer, memory and associated web-server. The CP allocation in one system is based upon User-CP centric actions or characteristics (A-C); Content centric A-C; Content Performance centric characteristics; and Viewer centric A-C. A compiler registers Users-CPs. An uploader delivers CP content to the web-server. A tracking module monitors views and acclamations on uploaded content. A revenue tracker accounts for revenue sources on the web-server. An allocation processor calculates CP payments. Metric examples are: CP centric (famous CP or frequent CP poster); Content centric (geographically relevant or trending topic); Performance centric (views on published content); Viewer centric (comments by famous critic). A payment module pays the CP through a banking system. Metrics are time-based temporal functions.

The present invention is a method and a system of paying a content provider (CP) who supplies content to a web-based server and is paid in accordance with an allocation from certain revenue sources by a payment processor. The system and method is adaptive to account for acts and events, both internal and external, at the time of, or shortly prior to the time of, web site posting of the content and to account for internal and external changed conditions during the content publishing period.

### BACKGROUND OF THE INVENTION

In order to increase the creation of online content by content providers (CP) and to monetize such content, it is helpful to compensate those providers based upon a wide range of factors, actions, events and conditions. Typically, CPs are compensated based upon the number of views or viewers of the CP online content. Ad revenue, sponsored ad revenue and subscription fees paid to the website-publisher of the CP content is sometimes shared with the CP. CPs are paid based upon a cost per impression or CPI. CPI is typically calculated in 1000 impressions/views. Also, CP revenue can be based upon a cost per click (CPC) or a cost per order (CPO). Sponsored ads are typically based upon CPCs. Sometimes CPO fees are better referred to as “referral fees” because the CPO is triggered when the user or visitor purchases an item or services based upon the displayed ad wherein the ad appears before or adjacent the CP content on the publishing website. Additionally, the website may require users or visitors to pay subscription fees. These subscription fees are also sources of CP revenue.

U.S. Pat. No. 8,145,526 discloses a method for sharing associated sales and referral fees which shared fees are paid to the content provider CP based upon predetermined formulas. The formula or algorithm accounts for various factors such as the content views, referral fees etc.

### OBJECTS OF THE INVENTION

It is an object of the present invention to provide a system and a method of paying a content provider for online content with an adaptive value calculator.

It is another object of the present invention to provide a payment processor and a method which allocates all or portion of revenue source fees (such as advertising fees (ad fees), sponsored ad fees, referral fees and user or subscriber fees).

It is an additional object of the present invention to allocate some of these revenues or fees to the CP based upon content provider centric actions or characteristics, content centric actions or characteristics, content performance centric characteristics and viewer centric actions or characteristics.

It is another object of the present invention to estimate these fees, then account for actual revenue and then pay allocated fees to the CP based upon temporal periods or events and the CP centric, content centric, performance centric and viewer centric actions or characteristic.

### SUMMARY OF THE INVENTION

The system and method for payment to a Content Provider (sometimes herein “CP”) for online content with an adaptive value calculator involves a web-based server coupled to the internet, and a payment processor computer and memory data storage. The payment processor is operatively coupled to the memory. Data from registering users is obtained and stored in a user's profile (UPP). This data may be directly input by the user or may be auto-populated by a spider or other auto-population module. The user profile data is stored in memory. The system and method also obtains, directly or indirectly, content in digital form which is uploaded to the web-based server. The digital content is directly provided by the CP or is indirectly provided by the CP pointing to another source as an approved upload from that third party source. Upon upload, the registered user is then defined as a Content Provider CP for the uploaded content.

The web-based server publishes the uploaded content on the internet. In a central system, the web server is combined with the payment processor. In a distributed computer system, the web server is a third party web server. In any event and in one embodiment, views and acclamations are monitored for the uploaded content. The monitoring of views and/or acclamations for the uploaded CP content includes monitoring various items, in addition to the gross number of views, including, if necessary, posted comments by others; approval and disapproval indicia (like, dislikes, favorites, one, two, three stars, etc); links to the uploaded content; links from the uploaded content; and social network postings and processing, tweets, retweets, etc.

In order to monetize the uploaded content (the content may be monetized with or with regard to the performance of the uploaded content), another revenue monitor tracks revenue or fees from one or more revenue source fees including advertising fees, sponsored ad fees, referral fees and user fees. These fees generate monetary revenue for the website server. The fees may be disassociated with the uploaded content.

The processing system allocates, to the content provider, all or a portion of the revenue source fees based upon several payment parameters. These payment parameters are generally grouped as first, second, third and fourth payment parameters. Sometimes, only first, second, and third payment parameters, thereby not accounting for the performance of the uploaded content. The first payment parameter generally refers to user-CP related or user-CP centric actions or characteristics. A CP centric action is, for example, the frequency of posting content. A CP characteristic is a more static event such as the fame or reputation of the CP. The second payment parameter is based upon content centric actions or characteristics. As an example, a content centric action is the acclaim from third party sites related to the content. A content characteristic is, for example, the quality of an audio-visual (“AV”) content uploaded by the CP or which the CP causes to be uploaded.

In one embodiment, the third payment parameter is based upon content performance centric characteristics, such as views, among other items. The fourth payment parameter (sometimes the third parameter if the content performance is not accounted for) is based upon viewer centric actions or characteristics. For example, a viewer centric action is the number of views of the CP online content. A viewer characteristic is visitor/viewer associated with a predetermined group, such as Rolling Stones™ magazine writer viewing an AV music video posted by the CP.

The system and method for payment to CP for online content includes the payment of money to the CP through a banking system wherein the payment is keyed to the provided online content and is based upon the allocation of the revenue source fees.

The system and method for payment to CP for online content has an adaptive value calculator because the first, second, third and fourth payment parameters (namely, the CP centric actions and characteristics, the content centric actions and characteristics, the content performance centric characteristics, and the viewer centric actions and characteristics) adapt to temporal or time-based events or periods. For example, the CP centric actions and characteristics are generally set at the upload event. The content centric actions and characteristics are based upon things at upload and prior to upload. The content performance centric characteristics are general measured over predetermined periods of time after the upload and publication of the online CP content. The viewer centric actions and characteristics are generally measured after the upload and publication of the online CP content. Since the various payment parameters, CP centric actions and characteristics, content centric actions and characteristics, content performance centric characteristics, and viewer centric actions and characteristics change in a time-based sense (a temporal function or feature), the system and method for payment for online CP content has an adaptive feature. The payment calculator or allocation module changes at any given time, based upon multiple factors.

In more detail, the first payment parameter—the CP centric actions and characteristics—is determined based upon one or more of: content uploading metrics based upon content provider acts; geographic location data associated with the content provider or the uploaded content; financial metrics based upon the uploaded content or other uploaded content provided by the content provider to the web-based server; fame metrics for the content provider; and content provider action metrics accounting for actions in connection with the web-based server. The server publishes the online CP content.

The second payment parameter—for content centric actions and characteristics—is based upon one or more of: a quality of the uploaded content; a quantity of the uploaded content; an acclaim metric for the uploaded content; a topic and content relevancy metric for the uploaded content; a temporal relevancy metric for the uploaded content; and, a geographic relevancy metric for the uploaded content.

The third payment parameter—the content performance centric characteristics—is based upon performance metrics accounting for internet views of the uploaded content, acclamation, comments, links, and social media interactions for the content.

The fourth payment parameter—viewer centric actions and characteristics—is based upon one or more of: viewer identity metrics for viewers of the uploaded content; temporal viewer metrics on the uploaded content; and, return viewer metrics for the uploaded content.

The payment processing system has a payment processor and a memory data storage. The CP provides or instructs or facilitates the upload of content to a web-based server. The payment processing system includes a compiler for registering users by obtaining a user's profile data and storing the same in the memory. An uploader delivers CP content in digital form to the web-based server. A tracking module monitors views and acclamations for the uploaded content published on the web-based server.

A revenue tracking module accounts for revenue source fees, including ad fees, sponsored ad fees, referral fees and user fees which generate revenue from the CP's uploaded content on the web-based server. An allocation processing module allocates or calculates, for the content provider, CP payments from the revenue source fees based upon two or more payment parameters, namely, the first, second, third and fourth payment parameters (CP centric actions and characteristics, content centric actions and characteristics, content performance centric characteristics, and viewer centric actions and characteristics).

A payment module pays the CP or effects payment to the CP through a banking system, for the uploaded CP content based upon the allocation of the revenue source fees.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates major functional modules for a payment processor in accordance with the principles of the present invention (the sequence of the functional modules can be altered to provide better system performance);

FIGS. 2A and 2B diagrammatically illustrate an exemplary flowchart for the content provider payment process (the sequence may be altered for better efficiency);

FIG. 3 diagrammatically illustrates a user personal profile (“UPP”) or CP personal profile (CP-UPP) as a UPP centric flowchart and functional module (sequence may be altered for better efficiency);

FIG. 4 diagrammatically illustrates the content centric modules (the sequence is changeable);

FIG. 5 diagrammatically illustrates the performance centric module for the content (the sequence being changeable);

FIG. 6 diagrammatically illustrates the compilation and processing of payment scores or allocations to the CP;

FIG. 7 diagrammatically illustrates a relationship process for processing content to account for external events, conditions, characteristics and acts;

FIG. 8 diagrammatically illustrates an exemplary system diagram for one embodiment of the payment processing system; and

FIG. 9 diagrammatically illustrates exemplary system diagram for a distributed payment system as another embodiment of the invention.

### DETAILED DESCRIPTION OF THE PREFERRED EMBODIMENTS

The present invention relates to a method of paying a content provider (CP) who supplies content to a web-based server, either directly or indirectly, and the CP is paid by a payment processor. The payment algorithm, generating a payment score or other event and condition driven accounting scheme, is adaptive to certain events, actions and characteristics of various items discussed herein below. These events, actions and characteristics may be internal, as in detected and measured in the payment processing system or may be external or outboard of the payment processing system. Similar numerals designate similar items throughout the drawings. An Abbreviation Table near the end of this patent specification provides abbreviations for certain items shown and described as functions and modules herein and as shown in the drawings. Some abbreviations are listed in the following text.

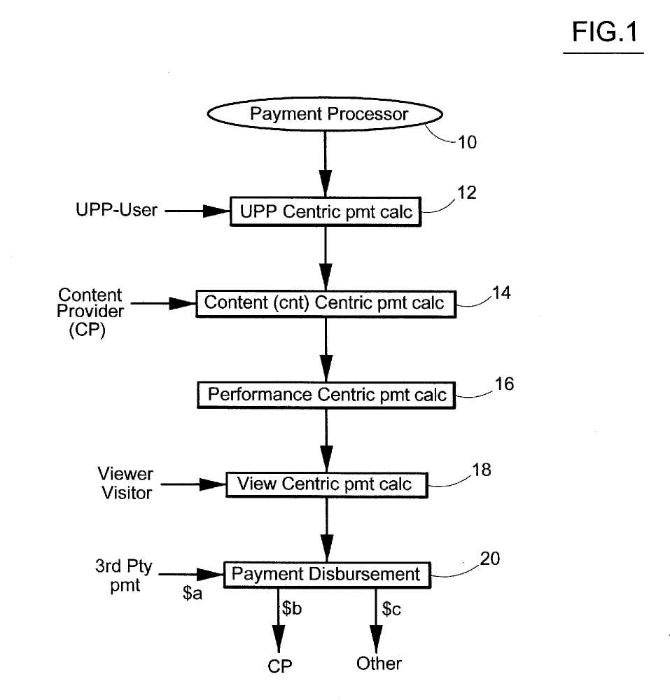

FIG. 1 diagrammatically illustrates the major functional modules for payment processor 10. It should be noted that many of these functional modules and other modules described herein can be reorganized in a different sequence in order to achieve a more efficient operation by persons of ordinary skills in the art. Also, certain functions can be combined. Due to the number of processing modules, some functions are redundant.

The payment processor system and method includes a UPP (user personal profile) centric payment calculation function 12. When the user uploads content, the user is then defined as a CP or content provider. The UPP-user is a content provider (CP). In some situations, the user is paid for another CP's content and this operation falls within the scope of the invention herein. For example, when a user posts a comment on another CP's online content, the user becomes a CP. “Online content” includes any online action resulting in content being displayed or revealed or published by a web server.

In order to utilize the payment system, the user completes a user personal profile (UPP) and then becomes a registered user. When the registered user, in a most typical situation, uploads digital content or effects the upload of digital content to a web server, that registered user becomes a content provider CP. Therefore, upon uploading the content, the payment calculator uses certain CP centric functions, characteristics and actions, in order to provide an initial calculation for payment of use-display-publication of the online content.

In functional block 14, a content centric function is executed and CP payment is allocated or calculated. Of course, the content provider must provide the content to function 14.

In function block 16, the performance of a particular content on the internet is monitored after the content is published on the website. A content performance payment score is calculated.

Any one of these functional blocks 12, 14 and 16, may employ partial allocations to the CP or payment scores may be utilized. If multiple CPs are integrated into a single payment system, a scoring system may be utilized rather than calculating a percentage of revenue. Whatever sum-of-payment term is employed, the Payment Processing System (“PP system”) monitors internal conditions, characteristics, acts and events and external conditions, characteristics, acts and events to calculate a pay-out for the content.

With respect to functional block 18, the viewer centric payment calculator, this calculator bases payment for the online content based upon visitor actions and characteristics. Functional block 20 indicates that payment is made to the CP. The third party payment $a represents money paid to the payment disbursement functional module 20. A portion of that $a revenue source fee is sent to the CP as allocation $b. Another portion $c is sent, delivered or applied as a credit to the website publisher (optional) and/or to the system operator (Sys Op) of the PP system.

The present invention utilizes a payment algorithm or process which accounts for various aspects of content, the actions and characteristics of the CP, the performance of the content and characteristics and actions of viewers of the published content. The process can draw from one or more various characteristics and actions. The following discussion of modules identifies some preferred actions and characteristics that could be utilized. As stated earlier, the Abbreviations Table near the end of this patent specification provides useful information for the abbreviations.

The following payment algorithms or payment processing modules are grouped into UPP-CP centric functional blocks (Section A); Content centric factors (Section B); Content Performance centric factors or metrics (Section C); and Viewer or Visitor centric factors (Section D).

A. Reg'd User (UPP-User)) and Reg'd CP (includes Reg'd Viewer as UPP-User).

Modules 410 to 488 relate to UPP-CP (user personal profile (UPP) and CP personal profile) centric payment metrics. A metric is a measurement of some discernable item. The payment system described herein effectively requires that a user, who submits content to be posted on the web server, first become a registered user. After registration, when the user submits digital content for upload to the web server, that registered user is reclassified as a content provider CP. In other situations, a user may be identified by the PP system and assigned a User-CP identifier (id).

There are two mechanisms to become a registered user/CP. The more common method is to have profile data obtained by input of data by the user into the PP system. However, the payment system may be configured to gather a user's personal profile (UPP) from any other type of user profile such as a social network profile or employment profile or professional profile, such as a Linked-in™ profile. In the latter case, the user/CP may be required to provide authorization to populate the UPP-CP personal profile in the PP or payment system.

The UPP-CP centric metrics are generally classified as relating to content upload event metrics or modules, geographic modules, financial modules, fame modules, UPP-CP profile data related to content modules, onsite behavior CP modules. It should be noted that these various modules generate payment score metrics and the modules may be separately executed and the metrics calculated separately or may be combined with different modules and metrics. Also, one or two metrics may be utilized and others disregarded. In general, unless otherwise specified, there is no necessary sequence of operation to determine a particular payment parameter based upon the metrics and algorithms set forth in modules 410 to 620.

1. Content (Cnt) Upload Event Modules

Module 410: Source and manner of Cnt upload to site. Newly uploaded Cnt called Cnt-DateCode. Different CP-Qual value scores assigned to each type of event—exclusive Cnt upload (high Cnt-Qual score), voluntary upload by CP or first time UPP-User, automatic upload from 3^{rd} Pty source, Cnt copied from 3^{rd} Pty site, Cnt share or linked.

Module 410 analyses the source of the content (cnt) and the manner in which the content is uploaded to the website. Newly uploaded content is keyed to a particular date (date code) and website publisher. A different CP quality value score is assigned into each type of event. If content is uploaded exclusively to the web server either directly by the CP or upon instruction to the payment processing system to upload the content from one third party website to the publishing website, a high value content quality score is assigned to the event. If the CP's content is automatically copied by the PP system (based upon a UPP-CP profile instruction), a lower payment score may be assigned. These events for module 410 are determined at the time of the upload. On the other hand, if the upload is voluntarily provided by the CP to the publishing website, a high score is posted. If this is the first content uploaded by the CP, another higher quality content score is assigned. Further, if there is an automatic upload command in the payment system such that once a CP uploads a certain information on a third party site, whether the content is a comment, a blog, a picture or an audio visual AV data upload into another site, per the CP-UPP, the payment processing system automatically copies that third party uploaded content into the designated web server publisher associated with the payment processor, this is a different quality content score. A different score is assigned if the CP copies the content from a different third party site and manually indicates to the payment processor system that this further copied content is to be published on the designated web server operatively associated with the payment processor. A lower content quality score is assigned if the CP only shares the content, tweets the content or provides a link to the third party posted CP content. Reference to third party websites is usually an external act or characteristic.

Module 412: If first Cnt upload by UPP-User (now called a CP), then assign higher Cnt-Qual score for first time event.

If the content is first uploaded by the user, now designated as a content provider CP, then a high quality score is applied to that content for a first time event.

Module 414: CP total aggregated as Cnt Quant uploaded by CP for all time (CP-Ag), CP-Ag for time windows” CP-Ag-Twindow24 hr, CP-Ag-Twindow1 week, CP-Ag-Twindow1 Month.

Module 414 is a metric which aggregates all the uploads from a certain CP. The metric measures a gross quantity of content for either all time (an aggregate data metric) and measures the content (Cnt) count over at different time periods, that is, with respect to multiple temporal factors. In other words, the CP would obtain a high payment score if multiple content uploads are provided within a 24 hour window. A different score would be assigned for a one week period. Another lower score would be assigned for content applied each month. Of course, this time based metric for supplying content (Cnt quant) could be combined with other modules and sufficiently altered. For example, if the CP was a regular contributor to a daily newspaper and generally posted a column in the newspaper once per week, if the CP engaged the payment processor PP system and shared and provided the payment processor with upload permission on a weekly basis to reproduce that weekly opinion piece on the associated publishing web server, then the one week aggregate time period for that particular CP would have a high value because viewers note the weekly temporal event. In other words, readers would expect the weekly posting by that CP and therefore this is a higher payment processing metric as compared with a different CP who works with a monthly magazine.

Module 416: CP content Quant on other 3rd Pty websites, CP content Quant on other web sites wherein 3rd Pty websites are ranked by Alexa.

Module 416 enables the payment processor to search other third party websites, not associated with the website electronically linked and monitored by the payment processor, in order to determine how many other content the CP has on his third party site. This is an external metric. In other words, the payment processor would send out a web search or spider to look for other content provided by the content provider on other third party website and increment the payment processing factor based upon other content issued by the CP. Further, module 416 would look at the relative popularity of this third party site as ranked by a website ranking service such as Alexa™.

Module 418: Frequency, velocity, acceleration of CP uploading various Cnt on site.

Module 418 looks at various posting time events such as the frequency of CP posting new content on the associated website. The frequency metric is an action or act. The velocity of posting is how many posts occur within one period of time as compared with a prior period of time. The acceleration of CP posting of content involves multiple follow-on postings and an increase in velocity. A popular news event such as the Egyptian revolution in 2013 may result in increasingly higher rates of posting of Egyptian events. This is an indication of accelerated postings. In general, frequency, velocity and acceleration metrics provide a higher payment score to the CP as compared with lower frequency, velocity and acceleration of uploaded content. Also, decreasing frequency, velocity and acceleration reduces the CP-Cnt score.

Module 420: Frequency, velocity, acceleration of CP uploading various Cnt on 3^{rd} Pty sites.

Module 420 relates to frequency, velocity and acceleration of CP content loaded on third party sites (external acts). As stated earlier, these third party sites are not directly associated with the payment processor.

Geographic (Geo) Modules

The geographic modules in this Section A(II), modules 422 to 426, generally relate to geographic centric conditions of the content or the content provider. As an example, during the Egyptian democratic revolution of 2013, the attention paid to this revolution by people in America was of high interest and therefore content Cnt relating to that revolution and Cnt from geographic location of the revolution is valued at a higher level during the time period of the revolution as compared with other events in Egypt prior to the revolution and after the revolution. The geo-locus of the Cnt and the CP is a payment metric.

Module 422: Current Geo loc of CP and/or UPP-User.

Module 422 determines the geographic location of the content provider then associates a payment score or metric to the content authorized to be uploaded by the CP. Trends showing interest in a certain geo-location may be part of this pay metric.

Module 424: Geo loc of Cnt when Cnt uploaded (may be geo loc of CP at time of upload).

Module 424 analyses the geographic location of the content when the content is uploaded. The geographic location or geographic relevancy metric may be ascertained by conducting a word analysis of the content. A later flowchart discussed herein has such relationship processes. If an AV content is uploaded, the voice track may be decoded into digital form and then analyzed by content analysis to match geographic location terms to a dictionary of places and countries. If a picture is uploaded, the picture normally has a headline or other comment field enabling the payment processor system (“PP System”) to determine the potential location of the content. These search routines and decoding operations are known to persons of ordinary skill in the art. Assigning a value by the PP system to any one of these modules and metrics may be provided by a scoring system. This scoring system by the PP system may be altered over time based upon experience and monetary payout levels to the CP.

Module 426: Current geo loc of CP/UPP-User in relation to geo loc of Cnt (when Cnt uploaded).

Module 426 looks at and analyses the geographic location of the CP at the time of the upload or shortly before the upload or shortly after the upload as compared with the geographic location of the content itself Again as an example, for the 2013 democratic revolution in Egypt, the value of content obtained by a CP in Egypt at that time has a much higher value than other content provided from CPs who are not in Egypt. Therefore, module 426 would provide a higher payment metric as compared with modules 422, 424.

III. Financial Modules

Financial modules 428 to 488 analyze certain data points and metrics from the CP profile (sometimes referred to herein as the UPP-CP).

Module 428: Past total aggregate $ paid to CP for all Cnt, CP-$-Total; metric for money owed to CP.

Module 428 analyzes the total amount of money previously paid to the CP for all content uploaded by the CP. Also, a metric or data point is determined based upon current money owed by the PP system to the CP. The metric is money-paid and money-owed. A modified metric is money-estimated for the CP content Cnt.

Module 430: Money $ paid to CP for this viewed Cnt, CP-$-CntDateCode-Total, same metric for money owed.

Module 430 is the amount of money paid to the CP for this particular uploaded content. Further, the data metric would look at total amounts paid to the CP for this particular content as well as the total amount of money owed to the CP for this particular uploaded content.

Module 432: Time-based metrics for pmts: frequency, velocity, acceleration, same for money owed.

Module 432 analyzes, based upon predetermined time periods (temporal factors), the amount of money paid to the CP. Further, the frequency of payouts, the velocity of the amount of money paid and acceleration factors may impact the payment to the CP for a particular content uploaded by the CP. The same type of metric analysis is provided for money owed to the CP. Another metric is estimated payments.

Module 434: Past total aggregate $ paid to UPP-User from all sources; same metric for money owed.

Module 434 analyzes the total aggregate paid to the CP when he or she was simply a registered user of the PP system from all revenue sources. For example, the PP system may have a loyalty rewards program that rewards content providers for any type of action on the PP system. These type of actions may be acclamation actions (likes or dislikes, rating, ranking or scoring other content, etc.), shares, links, tweets, re-tweets etc. Further, module 434 looks to money owed/estimated to the registered user.

Module 436: Past $ paid to UPP-User for specific 3^{rd} Pty Cnt, same metric for money owed.

Module 436 analyzes the past amount of money paid to the registered user for specific third party content. In some instances, the registered user may have other content posted on third party (external) site. There may be an economic and reporting agreement with these third party websites relative to the PP system. In other words, if the third party website pays the CP considerable amounts of money, the payment processing PP system may want to increase the payment metric score to that registered user if that registered user seeks to be converted to a content provider CP. A decrease metric may result if the UPP does not convert to a CP. The same metric is applied for money owed to a registered user for the registered user posting contents on other third party websites.

Module 438: UPP-User time-based metrics: frequency, velocity, acceleration, and money owed.

Module 438 determines moneys owed and paid and estimated to a registered user with time based metrics. These time based metrics would also include, in a preferred embodiment, frequency, velocity and acceleration as well as money owed metric data. In reference to time based metrics, various time periods are identified in certain modules and these time periods may be applied to or used repetitively for any particular module. See, for example, module 414 and examples of time metrics: all time, 24 hour, 1 week, 1 month and quarterly (optional), semi-annual (optional), and annual. Time metrics also include “for all time” and “for all time as CP” and “all time since a user is UPP,” time ratio of UPP time vs. CP time, etc.

Module 440: CP credit score, updated upon upload of Cnt.

Module 440 analyzes the CP credit score (a UPP credit score is also a metric). If the CP credit score has a high value, the PP system may assign a higher payment mechanism and metric payment score to particular content. A lower CP credit score may result in a lower payment score. The CP credit score may be updated upon each upload of content (other temporal factors may apply).

Module 442: UPP-User registered user credit score when the UPP-User visits Cnt.

Module 442 analyzes the registered user UPP credit score when the registered user visits content. If a registered user visits particular content and that registered user has a high credit score, the CP who uploaded the content should be rewarded for that high quality view. Temporal factors may apply.

Module 446: Fraud actions, black words, porn, manipulate payment algorithm in category Cnt and in other posted Cnt.

Module 446 general refers to negative payment score event. If the CP engages in fraud actions, or uses black words in Cnt (black words from a list of black or negative words), engages in pornography or pornographic events, or manipulates the payment algorithm in the PP system, the CP should be adversely effected by a reduction in the payment score. The same is true if the CP engages in other activities regarding content provided by other CPs on the associated website. The relationship flowchart discussed below may be employed.

Module 448: Fraud actions, black words, porn, manipulate payment algorithm on 3^{rd} Pty sites.

Module 448 involves fraud actions, the use of black words, pornographic events, and manipulation of payment algorithms on third party sites that are not directly associated with the PP system. This metric is applied to the CP and the UPP—registered user. However, the PP system may have an information sharing agreement with these third party sites in order to reduce inappropriate behavior by a particular registered user or CP and decrease money payouts.

III. Fame Modules

Fame modules 450 to 456 generally relate to the reputation and exposure of a particular content provider CP or particular content. Certain fame metrics are characteristics set at a defined time. Other fame metrics are acts which change over time. Fame is determined by internal and external processes.

Module 450: CP fame, measured by (a) CP name hits on search engine GOOGLE™, BING™, (b) content with CP byline on 3^{rd} Pty sites, (c) CP resume relevant to Cnt; (d) CP resume relevant to the event associated with Cnt, Cnt audience, target market for Cnt, merchandising associated with Cnt, (e) on search engines with search engine report (SR): CP name search with event relevant to Cnt, with Cnt relevant audience, with Cnt relevant target market, with Cnt merchandising; (f) measured at t Cnt upload; (g) measured at reg'd and (h) measured periodically (time windows), (i) measured upon rqt.

Module 450 measures the fame or reputation of the CP by various mechanisms. One mechanism would be entering the CP's name on an internet search engine such as Google™, or Bing™ (external fame process). The PP system could automatically populate a search string with the CP's name into one or more of these search engines and determine based upon the top 50 search results (SR) from the search engines the reputation and internet fame of a particular CP. The number of hits per 50 SR (SR-Quant) is one metric. The ranking of the CP in the top 20 SR (SR-rank) is another metric. In this manner, if a CP is well known and well established on the internet, a higher payment score could be assigned to content to be posted by the CP.

Another factor in module 450 is whether the CP's name is located by a search as a by line on third party sites. An additional payment factor is whether the CP's resume or biographic profile has any relevancy to the content. This may be automatically determined by either having the CP upload his or her resume into the user personal profile (UPP) at registration time, at the time of Cnt uploading or when the CP proposes to upload particular content to the PP system. The PP system may have a “pre-upload” calculator for proposed CP Cnt which may guide the CP and may estimate CP allocation payments based upon internal and external metrics. Otherwise, the system could automatically search for the CP's resume on other websites and automatically gather/obtain the resume or biographic profile into the UPP. For example, professional profiles may be found on Linked-in™. The Linked-in™ resume and profiles may be populated on an automatic basis onto the CP's UPP.

In order to determine whether the CP resume is relevant to the proposed/uploaded content, an algorithm matching content to relevant information into the CP resume may be provided. The Relationship Flow Diagram may be utilized.

Another aspect of module 450 is to determine whether the CP's resume is relevant to the event associated in the content or the particular content target audience or the Cnt target market or the Cnt target merchandise associated with the content. In a racing car scenario, if a famous automobile racing driver has posted content, there is a predefined market audience for that content and therefore that particular driver CP should be rewarded for posting content and with an allocation for the associated target merchandise to be advertised with the content.

Module 450 also takes into account search engine report data for the CP and compares the search engine report with particular events located in the content itself. There is a matching or near match content, context and taxonomic (CCT) algorithm which can be employed. These content and context and taxonomic associations are known to persons of ordinary skill in the art. Again, the relevancy of the content may identify a target audience, a target market or a marketing channel, as well as target merchandise associated with the content. These relationship metrics increase the payment score for the content.

Module 450 also utilizes various time based and temporal aspects. Therefore, the payment score for the content can be initially calculated at upload as well as measured upon the registration of the CP and measured periodically over various time based windows. Further, upon request of the CP, the PP system can reassess the payment score for module 450. Relational metrics can be recalculated with temporal triggers or upon CP request.

Module 452: Repeat Fame Module 450 for UPP-User, but assign different UPP-User Qual score for visit on 3^{rd} Pty Cnt.

Module 452 relates to the fame of the registered user UPP. A different payment score is assigned for the registered user if the registered user visits third party website content. A registered user UPP can have a fame metric assigned. The PP system is dynamic enough such that certain content is not designated as “compensable content.” For example, comments may not be compensable content, but a user's comments may be counted in the UPP. If the user becomes a CP, then this metric 452 bumps up the payment score.

Module 454: CP-UPP meets a predetermined user-visitor profile (a highly regarded critic). If the CP user-visitor is a highly regarded critic who posts a favorable comment/uploads CP-Cnt-DateCode, the content provider share of revenue may be increased (e.g., the New York Times food critic posts a favorable comment on a recipe blog entry posted by a content provider). Note differentiate reg'd CP and first time reg'd CP.

Module 454 determines whether the CP-UPP meets a certain predetermined user or visitor profile. In other words, if the CP is a staff writer for Rolling Stones Magazine™, at CP registration, the PP system may automatically recognize this fame criteria as meeting a predetermined UPP-profile-group. If the CP is initially proposing a blog or comment on the website associated with the PP system, the content for that particular CP should be rated higher than other content. Module 454 also integrates a temporal factor by linking the uploaded content to a date code and associating that date code with actions on other third party websites events. A timely comment responding to a recently posted blog should result in a higher payment score than comments posted long after the initial posting of the blog or AV material. Also, module 454 recognizes that the payment score should be increased for a first time CP who has just initially posted comments or digital material on the associated website. A CP who regularly posts comments on the associated website would not be entitled to that first time bump in payment score.

Module 456: When UPP-User wants to be first time CP poster, system does a web search to locate other postings by CP, and assigns “CP-Qual Factor”, and increments CP-Qual Factor for the first time Cnt posting. Subsequently, the reg's CP has a preexisting CP-Qual factor in the CP's UPP.

Module 456 is a metric which analyzes whether the registered user is a first time CP uploader. The system conducts an internet search to locate other postings by the CP and then assigns a CP quality factor to the payment score. This is an external characteristic. The payment score is increased for first time content posting. Subsequently, the registered CP has preexisting quality factors in the payment score based upon the CP's user personal profile.

IV. UPP Data Related to Cnt Modules

Modules 458-460 relate the registered user CP-UPP data and to the proposed content to be uploaded to the associated sites.

Module 458: UPP-User (and if UPP-User seeks to post Cnt and become a CP), current age, age when 1^{st} reg'd, gender, reg'd geo loc; UPP IP addr. at Cnt upload, reg'd IP residence; UPP-User interests posted by User in UPP, UPP-User friends, UPP-User social media networks and UPP-User social media data, UPP-User device specific data (operating sys., browser type, screen size, mobile ph), moving time window factored events, total aggregate time as UPP-User, time now on site, time on site during peak viewing time periods.

Module 458 is an analysis of the CP's UPP in order to determine the relevancy of the content to the potential audience and to ascertain the quality of the author of the content. Therefore, the CP's age, the age when the CP became a registered user, the CP's gender, the CP's registered geographic location as well as the internet protocol address of the content to be uploaded, the CP's registered internet protocol residence, the CP's interest that are listed in the UPP, the CP's friends who have been associated to the CP in the UPP, the CP's listed preferred device, and the CP's social media network also listed in the UPP all are metrics for the payment processor. If social media data has been added to the UPP, this is also a factor in this payment score. If the CP has identified a specific operating system or browser type or device specific data (cell phone, tablet), this also is a factor in qualifying and allocating the payment score for the content. In addition, temporal factors are related to these various UPP characteristics and dynamic actions based upon CP-UPP data changes in the CP's UPP. Initially, this metric is a characteristic. With changing data, this metric is an act or an action. These factors are used to value the content. This is a characteristic metric.

The total amount of time the CP has been a registered user, the amount of time the CP spends on the associated website, the time of day the CP is on the website is also a factor. If for example the CP is commenting on a television show that is being played on prime time and always posts comments on the show at that time on the associated PP system-website, the CP and this content should be given a higher payment score as compared with other content posted by the CP about the television show which is not posted during the TV show time. Non-live action comments are worth less than live-action comments in the payment score.

Module 460: CP/UPP-User relationship with Cnt, tested by relationships of UPP data as compared to Cnt content, context and taxonomic analysis (“CCT” analysis).

Module 460 relates the CP's UPP data with the content. A relationship testing is made by content analysis of the UPP and the content to be uploaded as well as the context relationship and taxonomic analysis. This content, context and taxonomic analysis (“CCT”) is known to persons of ordinary skill in the art. However, assigning a payment score based upon the UPP data and content data is not known.

V. On Site Behavior Modules

Modules 460 to 488 relate to the CP's onsite behavior (onsite the website associated with the PP system). In other words, the CP that regularly visits the associated website should be rewarded higher payment for content posted on the associated website as compared with other CP's which do not spend significant time on the associated website. As described earlier, the associated website is the website where content is posted by the PP system and where the PP system posting and tracking modules monitor the revenue and the visitor traffic on that associated website.

Module 460: CP and/or UPP-User behavior on website in general, posting of comments, messages, tweets, likes/dislikes, favorites, links to 3^{rd} pty Cnt, other on site metrics.

Module 460 is a payment metric which analyzes the CP's behavior on the website associated with the PP system in general. A website is “associated” with the PP system if the site has tracking modules on site and a revenue reporting system, method or routines which report revenue source fees to the PP system. Otherwise, the website is classified as a third party website. The degree of association is based upon the demands and requests of the Sys Op of the PP system. There may be degrees of association permitted to operate the payment method and system described herein.

Returning to Module 460, if the CP posts many comments about third party content on the associated website, this may increment the payment score. If the CP never posts comments about third party content on the associated website, this may decrease the payment score. In a similar manner, the CP's posting of messages, tweets, acclamation information such as likes or dislikes, listing certain content as favorites, links to third party CP content (content by other CPs) that are posted on the associated website and other website behavior metrics increase or decrease the payment score. This is an act metric.

Module 462: CP and/or UPP-User Quant time on site (Quant visits by CP/UPP-User to site).

Module 462 analyzes the amount of time the CP spends on the associated website. Accumulated time or quantity (Quant) of time units may be measured as a metric. Quant time is measures whether he or she is a CP or only a registered user with a UPP. As discussed earlier, a registered user may visit the associated website for considerable amount of time and then later be converted to a content provider CP when that registered user begins posting contents.

The onsite behavior module 460 to 488 encompass behavior prior to posting content as well as subsequent posting content. Module 462 analyzes the CP whether the user is a CP or simply a registered user and measures the amount of time the CP-User-UPP has spent on the associated website.

In addition, the total time and a number count for CP-UPP visits to the associated website is used as a metric. The amount of time is an aggregate and the number of visits shows frequent returns by the user and these metrics are payment factors.

Module 464: CP/UPP-User ratings or rankings of 3^{rd} Pty Cnt (Cnt posted by others on site), CP/UPP-User comments, messages, tweets, likes, fays on 3^{rd} Pty Cnt,

Module 464 provides a payment score based upon the CP's and user-UPP's ratings and rankings of content posted by the CP-User on third party websites. If the CP-User is active in commenting on third party content posted on third party websites, this may increase or decrease the payment score as the system operator (Sys Op) desires. The posting by the CP-User of comments, messages, tweets, acclamations such as likes or dislikes or favorites on third party content affects the payment score. If the PP system is exclusive, these metrics are used in a negative manner. If the PP system is an aggregator, these metrics are positive.

In general, many of the metrics discussed herein may be converted into negative payment score elements rather than the positive score elements discussed herein. For example, a CP or registered User-UPP may start with a score of 1000, and then negatives may be applied (visits to third party sites as detected by browser history and ad network tracking devices (these ad network tracking modules are known to person of ordinal skill in the art)). Therefore, reference herein to primarily positive scores are illustrative only because the Sys Op may configure the PP system is more broadly track and report negative payment scores rather then accumulate positive payment scores from these metrics. In general, all the CP metrics can be applied to a registered User-UPP to enable payment and loyalty programs and fee referral systems and methods.

Module 466: Quant CP/UPP-User's responses, comments, likes/dislikes. marked favorites to Cnt posted by CP see also follow-on comments/messages/tweets etc.

Module 466 is the quantity of CP's responses, comments, acclamation indicators and indicia (yes, no, likes, dislikes, star approval 1 to 5, disapproval ratings 1 to 5, etc.) and favorites (fays) on content posted by the CP. In other words, the CP in commenting on or responding to comments on his or her uploaded content is a factor for increasing or decreasing the payment score. For example, if the CP has posted a blog on the associated website and other registered users or other visitors have posted negative comments on the associated website for that CP blog and the CP posts a follow-on comment that is derogatory to the other registered user's comments, the payment score may be decreased. A negative response by the CP to positive criticism by other registered users or visitors is a negative event which decreases the payment score. However, positive responses by the CP as follow on comments to CP's content should be rewarded by increasing the payment score. Critical comments which are welcome by the CP should be rewarded if the CP recognizes the value of the critical comments.

The same is true regarding messages, tweets, favorites, likes, dislikes and other indicia of acclamation.

Module 468: Once Behavior Module factors 460-466 are determined by the Sys, then Sys assigns initial CP-Qual value to the CP and assigns initial UPP-User-Qual value to the following CP/UPP-User's actions in follow-on Modules 470-476.

Module 468 notes that once the online behavior modules in modules 460 to 466 are determined by the PP system, the PP system assigns an initial CP quality score, value or payment score to the CP. This initial CP quality or payment score or initial registered user quality or payment score supports the additional payment scoring in the follow-on modules 470 to 476.

Module 470: Aggregate t on Sys site: UPP-t-Site-Total-Time,

Module 470 aggregates the total amount of time the CP or registered user spends on the associated website. This is an act metric.

Module 473: Aggregate t for all visits on specific Cnt: UPP-CntDateCode-Total-Time

Module 473 aggregates the number of visits (frequency and Quant count) and the time for the visits (t-AGG) on specific content. Time on Cnt shows stickiness of the content. Therefore, the system aggregates registered user data, the content date code (identified for a particular content), and the total amount of time the registered user has spent viewing that content on the associated website.

Module 474: Current t on specific Cnt: UPP-CntDateCode-Vdate-Time-Now,

Module 474 determines the current time spent on specific content. In other words, if users spend considerable amount of time on a particular content posted by a CP, this indicates that the content has a high value to those particular targeted registered users for the CP. The same is true for the CP. However, time on Cnt by the CP may be a negative factor since the CP may be gaming the payment system and seeking to drive up the payment score. However, good Cnt which causes another CP or User-UPP to “stay on the Cnt” shows a target audience. The payment score should be increased. If on the other hand, a short amount of time is spent on that content for the designated audience (the target audience determined by matching the proposed related merchandise for sale with the Cnt with UPP data for all registered users UPP), a negative payment score would be assigned. Effectively, the Cnt does not sell the merchandise to the target audience or market.

Module 475: CP/UPP-User returns to site: UPP-Site-Returns

Module 475 quantifies the number of CPs and User-UPPs that return to the content site on the associated website. Also, the same or multiple returns by registered users to a particular posted content is important. Module 475 is return to website. Module 476 is return to Cnt. The Quant of returns shows high interest Cnt that should be rewarded. The Quant of returns to website shows an increase in general awareness and the relatedness of the Cnt to the associated website.

Module 476: CP/UPP-User returns to specific Cnt: UPP-CntDateCode-Returns

Module 476 determines whether the CP or registered user returns to a specific content. In contrast, module 475 analyzes the number of times the CP returns to the associate's website. In module 476 the system determines how often the CP returns to the specific content. The same is true regarding registered users returning to the associate's website (module 475) or the registered user returning to a specific content. Specific content is identified, in this example and in this patent specification, as a content date code.

Module 480: First Time Cnt posted by UPP-User, repeat metrics Modules 470 to 476 and increment for “New-1st-T-CP”

Module 480 provides an increase to a payment score based upon first time content posted by a registered user. Further, module 480 repeats the payment metrics for module 470 to 476 and provides an incremental bump to the payment score for a first time poster of content. A first poster Cnt metric rewards new CPs.

Module 482: Unit time Quant-CP or UPP-User time units on specific Cnt (amount of time units visitor in on the Cnt page, for example number of times the CP or UPP-User spends 10 sec on Cnt, “10 sec” time units). This generates CntDateCode-Vdate-Time-Units, metric on a per CP or UPP-User basis. Also metric on the aggregate during time window, metric on aggregate all CP or UPP-Users

Module 482 relates to the average, mean or median amount of time spent by a CP or registered user on a certain posted content. If a number of users spend over 30 seconds viewing a particular blog, this blog content should be provided with a higher payment score as compared with another blog or content wherein users-CPs only spend 5 seconds. Therefore, time on content as quantified by time block units (e.g., 5 sec. blocks is 1 unit) is important. This is an indication of the amount of interest the content generates with a target audience or an audience subject to targeted merchandise.

Module 484: Mean and average and median time Quant: t factor per CP or UPP-User (the longer time CP or UPP-User stay on the specific Cnt page the higher quality Cnt-Quaff score), see Time-Ave-Quant-CntDateCode, calc mean time-on-Cnt, average time-on-Cnt, aggregate all CP or UPP-User time during time windows, aggregate all CP or UPP-User time on specific Cnt for all time.

Module 484 analyzes the mean, median and average time or quantity time factor for each content provider or each registered user. Module 484 calculates the mean time on content, the average time on content, aggregates all the CP and registered user time during time windows as a quantitative number (150 users spent 101 units of 10 seconds or more time on specific content). This provides additional marketing value to the content. Therefore, the CP should be rewarded for the higher level of interest on the content he or she provided.

Module 486: Return to Site metrics: Frequency of return to specific Cnt published web page; velocity of returns; returns to site after visit to specific Cnt, returns to site from another 3^{rd} Pty t website, metric on a per CP or UPP-User basis, aggregate all CP or UPP-User returns for all time, for time windows.

For Module 486, the importance of return to website and returns to Cnt is discussed earlier. This metric measures frequency and acceleration ro return to site, return to Cnt measurements. Also, this metric studies referrals form third party websites not associated with the PP system. Referrals to 3^{rd} Party websites is also measured. Returns to and referrals from and referrals to a quantifies and scored.

Module 488: Type and Quan of “shares” for Cnt from and to 3rd party sites by CP or UPP-User, email shares, social ntwk shares, share velocity, share Quant for certain time windows, share Quant for “all time”, metrics per CP or UPP-User, metrics for all CPs and all UPP-Users over certain time windows, metric on aggregates for all Cps and all UPP-Users for all time.

Module 488 quantifies the type and quantity of “shares” for content to and from third party sites (those third party websites not associated with the PP system). A share is a link or other electronic coupling to or from the Cnt. Therefore, the amount of shares and type and quantity of the shares for a particular content is monitored in module 488. A share could be a site, an email, or a share designated by a social network. The metric also involves analysis of velocity, acceleration and number of total shares for a particular content. The number of shares over a certain time windows, and the total number of shares for all time is a metric.

It should be noted that these time or temporal factors can be used in modules and metrics in most of the payment modules.

Further, the number of shares and share metric for all content providers and all registered users over certain time periods is helpful. The payment score is increased or decreased according to further analysis by the PP system.

B. Content Centric factors (internal and external).

The content centric factors involve an investigation and analysis both internally (within the PP system) and externally (where the system gathers data outside of the PP system) regarding the payment score. Modules 490 to 548 provide the algorithms for these payment metrics.

I. General Characteristic Modules

In this section, modules 490 to 498 analyze the general characteristics of the content (“Cnt”).

Module 490: Supplied Cnt quality (Cnt-Qual)(high or low quality image or audio-visual (AV)(e.g., grainy), format (e.g., HD). Engage Cnt-Qual module and/or Text-Qual module.

Module 490 analyzes the quality of the content proposed to be posted or published on the associated website. The PP system may have a “pre-posting” analysis of the Cnt and may then estimate the payment score. this is an incentive to user-UPPs and to return Cps. Quality of Cnt is a factor. A high quality image or AV material is assigned a higher payment score as compared with a low quality image (grainy) or AV material (re-recorded AV material). For example AV material is less valuable than high quality HD AV images. In conjunction with module 490, module 410 may be engaged to again quantify for payment score the quality of the content. Also, the quality of the text may be analyzed based upon spelling errors, grammatical errors, formatting errors, bad punctuation, etc. There are programs which provide a raw score for this metric.

Module 492: Cnt type: AV, blog, audio, h-link, pdf, ppt, excel, Q&A, maps, 3d models, avatars.

Module 492 analyzes the type of the content. Certain associated websites are heavily tilted towards AV material whereas other websites are primarily text based such as blogs or news presentations. There are other associated websites for audio. If only a hyperlink to this Cnt is provided “as content” to the PP system, this is a low score characteristic. The link is a static event and therefore a characteristic. Pdfs, powerpoint (PPT)™, excel™ spreadsheets, question and answer results, comments, follow-on comments and secondary comments and third follow-on comments, maps and 3d models and the use of avatars may all be scored with payment algorithms in module 492.

Module 494: Cnt Quantity: Engage quantity (“Quant”) module. Measure column length for blog or comment text (1.86 inch wide, e.g., Text-Cnt-Quant. Unitize comment, message, tweet. Calc run time for AV. If exceed max'm then negative Qual, if AV is typical (set by category of Cnt) rate high Qual, if below min'n rank low Qual.

In module 494, the quantity of the content is analyzed. Some content is too long and this may result in a negative payment score. Some content is adequate for a particular type of associated website and this is scored higher. For example, regarding text, the text may be quantified based upon a standard newspaper column which is 1.86 inches wide at set at a certain font size. Therefore, different textual materials can be quantified (text to text) based upon this newspaper standard or unitization. The Sys Op may engage other unit standards for types of Cnt for the payment processing system. For example, a word count in text. Also, the size of the photographic image is a quantity. size may be memory units. The length or run time of an audio file or the length of an AV file is another mechanism to quantify the amount of content. The same techniques can be utilized to unitize comments, messages and tweets.

Module 496: Source Qual indicator: blog or AV from professional or news reporter (high Qual) vs. miscellaneous UPP-User (lower Qual).

The source of the content is an indicator of quality and is a characteristic. If the content is from a blog or AV content is from a professional or news reporter service, this is assigned a higher payment score as compared with a first time content filmed by a hand held camera of a dancing cat. The Cnt source data is generally obtained by Cnt source analysis. the CP may be required to complete a questionnaire prior to the PP system posting or publishing the Cnt on the associated website. This CP form may identify copyrighted material owned by others (resulting in a negative score). The headers on AV material may be automatically scanned by the PP system, for scoring purposes.

Module 498: Match Cnt to other Cnt on site and on 3^{rd} Pty sites. If AV images match other high Qual images or AV, then assign high Qual to Cnt. Example: cartoons in AV with images that match other viral images, see e.g., Pawz characters.

Module 498 is a metric matching the current content either currently uploaded or proposed to be uploaded with other content on the associated website. As may be surmised, the PP system may operate with multiple associated websites. One website may be dedicated to persons who enjoy automobile racing. Another website may be targeted to persons who enjoy music videos. If content for automobile racing website shows a dance routine by a famous driver, this content may have some nominal relationship to the music video site. In this sense, cross-referencing and comparing the content on the racing driver website with the content on the music video website may result in a higher payment score. Cross market Cnt is more valuable (see music that plays well in country and rock venues).

The same analysis can be applied to content on the associated website as compared with content on the non-associated or third party websites. If the audio visual images match other AV images on third party sites, then the PP system may assign a higher payment score to that video. If the quality is the same, then a higher score is assigned. The concept is that multiple appearances on the internet of certain Cnt, when the third party Cnt matches to CP's Cnt for the associated website, provides enhanced value to the associated website and to the value of the content itself.

Further, an image analysis can be engaged with the photo images and the AV images to determine whether the images match other 3^{rd} Pty Cnt images common on the associated website.

An example of the CP Cnt that is a match to a cartoon done in AV format that matches the PAWZ™ characters widely known by persons of ordinary skill in the art on the internet. The PP system matches the known PAWZ™ image to the CP's image or AV material. Image matching routines are known by persons of ordinary skill in the art.

II. Critical Acclaim—Response Modules

Modules 510 and 512 generally relate to critical acclaim or responses to content on the internet. In general, these are acts or actions which are dynamic or changing in nature.

Module 510: Critical Acclaim—Negative Reaction by 3^{rd} Ptys. Cnt rated good or high Qual by critic. Critic-Commentator has a Critic-UPP score and this critic score effects the Cnt-Qual score and the high, average or low rating assigned by the selected by the Critic.

Module 510 measures the critical acclaim as well as the negative reaction by third parties to the content. Critical acclaim that are likes and listings as favorites generate a higher payment score. In general, negative acclaims such as dislikes and comments that involve black words such as hateful, obscene or pornographic textual references may be assigned a lower payment score by the system operator. Some associated websites for adult content may rate obscene comments as a high pay metric.

By establishing filters for negative comments and filters for positive comments, the PP system can automatically rate and adjust the payment score based upon these critical acclaims and indicia, both positive and negative reactions by third parties.

In addition, module 510 ascertains who is posting the comment to a particular content. If the commentator is a critical acclaim and high value registered user score in his or her UPP, his or her comments to particular content affect the payment score for that content.

Module 512: Critical Acclaim—Negative Reaction on 3^{rd} Pty sites. Poor Cnt-Qual ratings by others on 3rd party sites. Sys searches 3^{rd} Pty sites, scrapes comments, does word analysis on comments, and assigns a Critic-3d-Qual marker to Cnt. Also, 3^{rd} Pty site has a 3d-Site-Critic score and this 3d-Site-Critic score effects the Cnt Qual score.

Module 512 focuses on the critical acclaim and the negative reaction for a particular content based upon information based on third party websites. Again, the information from third party websites (obtained externally) can be obtained by adequate searching programs established by the PP processor. Payment scores are lowered based upon negative comments scraped or obtained from third party websites. Again, if a well known critic (see his/her UPP) dislikes a particular AV material and the PP system has UPP information on that critic (whether the critic is a registered UPP or is a visitor designated UPP (V-id, see below), then the negative comments by this critic—UPP results in a lower score for that posted content.

III. Subject Analysis Modules

Modules 514 to 542 analyze the subject of the content posted and develops payment scores based upon subject matter. Sometimes these metrics are characteristics and sometimes they are acts.

Module 514: Subject topic—CCT Analysis (content, context and taxonomic CCT). Analyze subject, title, key words, descriptors, combine all comments on Cnt. Id “good” and “bad” words and expressions for Cnt. Assign Qual score.

Module 514 analyzes the topic of the content with an analysis including content analysis, context analysis and taxonomic CCT. This type of CCT analysis is known to persons of ordinary skill in the art. Further, the PP system can analyze the subject, title, key words, descriptors and combine all the comments into a value score or payment score. Bad words and negative content identified in the CCT analysis may reduce the payment score.

Module 516: Taxonomic Analysis of Cnt. Establish relevancy levels and Taxo categories. Sys follows Cnt-Taxo categories for trending hot topics. Example: movie Slumdog Millionaire caused an increase interest in Bollywood movies and Indian music.

Module 516 involves a taxonomic analysis of the content. For example a taxonomic system is a system of classification. In general, items higher on the taxonomic list are generalization categories as compared with items lower which are specific topics under a specific category. To ascertain high quality content, the PP system may first conduct a taxonomic (taxo) analysis of the Cnt, determine the various classes describing or encompassing the Cnt, search the internet for similar content/class content and then match the proposed Cnt to the retrieved content for quality, contextual relationships (relationship of words to other words), spelling, grammar, etc.

The system operator of the PP system may establish relevancy levels within a certain taxonomic category system. The PP system may follow content related taxonomic categories based upon trending hot topics. For example, if the Reddit™ internet website is trending a particular topic regarding a celebrity, then other Cnt for other celebrities that are involved in that general taxonomic category (for example drug abuse) may be rated with a higher payment score as compared with other celebrity news which does not involve drug abuse. Further, the association of one type of content relating to a general category may be valued at a higher score compared with a more narrow taxo class (compare general mathematics to quantum mechanics). Another example given is the popularity of the movie Slumdog Millionaire™ which caused a consumer interest increase in movies made in India, Indian clothing and an increase in interest in Indian music.

Module 518: Content Analysis. The words in the Cnt are analyzed and title, headers, sections, topics and are assigned greater weight than words in the Cnt itself, and extracted content words and the CP-assigned key words and descriptors are run through a trending module which looks at 3^{rd} Pty sites at certain times. At t upload, at 24 hr t, at one-week t, then monthly t. CP may RQT content analysis. Cnt Qual score assigned.

Module 518 involves further content analysis. The words in the posted content are analyzed such as title header sections. Some words are assigned a greater weight by the PP system as compared with other words. Word value weighting is used by the PP system. The interesting words can be extracted and run through trending module which looks at third party websites at certain time frames. These time frames may involve a PP system analysis (a) at the time of content upload (a characteristic, generally static event); (b) within a 24 hour period (an act, dynamic metric); (c) at a one week interval from the date of posting; (d) and then on a monthly basis. In this manner, if earlier posted content becomes relevant because of a later developing trending hot topic identified in various trending system (for example Reddit™), then the content can be reposted by the PP system and reassigned a higher payment score. The CP can request re-scoring of the payment allocation.

Module 520: Geo loc of CP as geo loc relates to other Cnt on site.

Module 520 identifies geographic location characteristic (Char) of the content as the content relates to other content on the associated website. This may increase the payment score for the then uploaded content.

Module 522: Geo loc of Cnt as geo loc relates to other Cnt on site.

Module 522 relates the geographic location of the content as that location relates to other content on third party websites.

IV. Relation to 3^{rd} Pty Material Modules

Modules 524 to 532 generally associate the subject content (that is, the content soon to be uploaded by the CP or content just recently uploaded by the CP) to content on other non-associated third party websites.

Module 524: Event data. Relevancy of the Cnt to events and the time-based relationship of Cnt to events. E.g., a 3 day concert event, and the Cnt is supporting customer services such as hotels, food, transport, etc. Qual factors effected by CP Cnt uploads (Quant), frequency of upload, Sys searches for $ values through other Cnt from 3^{rd} Pty sites (cost of Madonna concert tickets drives up Cnt value for Madonna Cnt on site). Trending Cnt on other 3rd party websites. Qual on 3rd party sites.

Module 524 engages in event data analysis (a Char and a dynamic Act metric, both internal and external operations). An analysis is conducted on the relevancy of the uploaded content to event trending on third party websites (Char). Also, there is a time based relationship of the trending content on third party website to the uploaded content (Act). The example is provided that for a three day concert event in Upstate New York (a geo location, and an event name and performer names), content relevant to consumer services such as hotels, food and transportation one day prior to the event and three days during the event and 1-2 days after the event are relevant to the three day concert event. Therefore, content posted one month before the event for related to the customer services and facilities has a higher commercial value and a higher payment score due to the three day concert event.

Quality factors are applied to the CP content as well as the frequency of upload. The number of internet searches for the three day concert event (SR for event—external), the number of searches for the content category (hotels, compared to hotels in Upstate New York), et al., increases the value payment score. Further, the cost of the tickets for the three day concert event (scraped data, external) and the increase in ticket prices (velocity, acceleration) further increases the payment score for the supporting customer services and facilities. The PP system may again analyze trending data from third party websites and the quality of the content on those third party websites in order to ascertain the payment score for the uploaded content for Qual, for Relevancy and onsite PP system interest.

Module 526: Rank of Cnt in search engine results. Initial search engine ranking of Cnt. SR ranking of CCT analysis of Cnt (subject, title, key words, descriptors, combine all comments on Cnt). Periodic SR Quant and SR ranking. SR rank analysis triggered by Viewer Quan or Viewer velocity.

Module 526 ranks the uploaded content (or proposed Cnt) based upon search engine results (SR). In this module, the PP system uses keywords from the content extracted by the CCT analysis and conducts an internet search for those keywords through common search engines. The PP system can then do a search result ranking of these keywords which result in a higher or a lower payment score. If more keywords appear in the first ten results of the search result (SR) ranking, this results in a higher payment score (Char metric). If the term extracted by CCT analysis does not rank high in the search result, this results in a lower payment score.

Module 526 also contemplates a periodic search result quantity and a periodic search result ranking (Act metric). Search result quantity is just the number of hits within a certain internet search group, such as 24 hits is a 50 item search engine SR. Only 24 hits listed the keyword. Search engine ranking is how many hits occur in the first 10 search results (1^{st} page of SR).

Module 526 also contemplates the data metric of conducting a search result rank analysis based upon viewer quantity or viewer velocity. In other words, once the content is uploaded, if there is a viewer quantity threshold exceeded, the PP system may engage the search result Quant and SR rank Quant analysis to increase or decrease the payment score. Viewer velocity on uploaded content is also indicative of a trend and this trend may be confirmed by analyzing search result quantity and search result ranking.

Module 528: Time factors for all events and metrics, real time at View, periodically, Viewer velocity triggers.

This payment metric engages time factors for these third party events and engages a real time analysis of views on the uploaded content. Periodic metric reviews of the uploaded content compared to content on unrelated third party websites can be engaged. Also, viewer velocity triggers (thresholds) can be established by the PP system which causes a repeat of module 524, 526 and a further increase or decrease on the payment score. The PP system has an index of key terms for the Cnt. Periodically (e.g., daily) the PP system does a trend analysis of 3^{rd} Pty websites with the key index. Hot topics are re-posted by the PP system and the payment metrics increased. Lower trending topics (see taxo analysis for topic headers) results in lower payment metrics.

Module 530: Geo loc of CP as it relates to geo loc of other 3^{rd} Pty SR results and trending results.

Module 530 identifies the geographic location of the content provider CP as it relates to the geographic location of other third party search engine results and trending results. Again relating back to the 2013 Egyptian Democratic movement, the geographic location of the CP indicates that if the CP is an Egyptian in Egypt during this time frame, this content associated with the geographic location of the CP has a higher value. The geo location of the CP is a factor when the Cnt is uploaded (Char metric). This higher value can be ascertain automatically based upon third party search result for that geographic location and the associated trending result from trending sources such as Reddit™.

Module 532: Geo loc of data in Cnt as it relates to geo be of other 3^{rd} Pty SR results and trending results.

Module 532 identifies a geographic location of the uploaded content as that geo data relates to the geographic location of third party content and third party search results and trending results.

V. Performance Factor Modules

Modules 534 to 548 analyze the performance of the content, that is, the uploaded content. These are act metrics because they are dynamic in nature.

Module 534: Velocity of views. Increase Qual score.

Module 534 analyzes the velocity of views. An increase in velocity of views on an uploaded content results in an increase in quality score for the content. Sometimes herein the “Qual score” is a payment score. At other times, Qual refers to the quality of the Cnt.

Module 536: Velocity of comments/messages/h-links. Increase Qual score.

Module 536 analyzes the velocity of comments, the velocity of messages, the velocity of hyperlinks to the uploaded content, the velocity of hyperlinks from the uploaded content, and therefor increases the quality score and the payment score.

Module 538: Interaction on posted Cnt. SR rating of Cnt comments, favorites, views.

Module 538 is a data metric based on interaction with the posted content. If the search engine ranking of comments for the uploaded content, favorites for the uploaded content, acclamation, and CPI or viewers of the uploaded content increases, this increases the payment score. A reduction on these items or when the PP system sets minimum thresholds for views, comments etc., this results in a decrease in the payment score. In this manner, the present payment processing system is adaptive to the changing conditions of the content of the viewers of the CP and other factors discussed herein regarding the various algorithms and data metrics accumulated to ascertain an appropriate payment score for uploaded content.

Module 540: Type and Quan of “shares” on 3rd party sites, email shares, social ntwk shares, shares during predetermined time windows and total time and total shares

Module 540 analyzes the type of shares for uploaded content and the quantity of shares for the uploaded content with respect to third party websites. Accordingly, email shares, social network shares, tweets, links to, links from, SMS text links, and shares during predetermined time windows (1 hour, 24 hour, 1 week, etc.) are part of the payment scoring process.

Module 542: Re-Posting and upload/download to 3^{rd} Pty sites.

Module 542 involves reposting the content on non associated third party websites and uploading and downloading of the uploaded content to other third party websites. In some situations, the PP system will increase the payment score based upon multiple uploads of the content to non associated third party websites. In other instances when the PP system is designed to be the exclusive provider of certain content, the posting of identical content or substantially similar content on non associated third party websites reduces the payment score.

Module 544: Ranking by 3^{rd} Pty Sites upon Re-Posting and upload/download. Type of 3^{rd} Pty site.

Module 544 applies a metric of website ranking to the Cnt. An example of website ranking is Alexa™ ranking service. Cnt on higher ranked websites is more valuable. Reposting may be a positive pay marker or a negative metric as determined by the Sys Op for the PP system.

Module 546: An Unreg'd User or a UPP-User or a CP meets a predetermined user-visitor profile (a highly regarded critic) and views Cnt. Cnt Qual score increases. If the user-visitor is a highly regarded critic who posts a favorable comment, Qual score increases. If CCT analysis of Critic, Critic resume and other Critic postings on 3^{rd} Pty sites closely matches Cnt-CCT characteristics, the Qual score increases. Example: the CP share of revenue may be increased if the New York Times food critic posts a favorable comment on a Cnt recipe blog entry posted by a CP.

Module 546 relates to a unregistered user (Visitor, see V-id later) viewing the content as well as a registered user UPP or another CP viewing the Cnt. If any one of these individuals meets a certain user-visitor profile, then the uploaded content payment score is increased. In other words, if a user visitor is identified by the PP system as a well known critic of movies, even though the visitor is not a registered visitor (see V-id below), the PP system may have an unregistered visitor personal profile (V-id) which identifies that visitor or viewer of the uploaded content as a well known critic. In this case, the PP system will increase the payment score. The PP system can automatically determine whether the user visitor is a well know critic by engaging a search engine search and also engaging third party ad networks to identify the critic associated with a particular internet protocol address. This activity of matching an unregistered visitor to a particular group profile is known by persons of ordinary skill in the art associated with ad network processing. Further, the PP system may analyze the unregistered user as a critic based upon CCT analysis of the critic's resume.

If the visitor is a registered user, this information is in the UPP profile.

Module 548: Cnt Qual over time. Sys periodic searches re copies of Cnt, ranking on 3^{rd} Pty sites, play time on 3^{rd} Pty sites. If Cnt authenticated on 3rd Pty site, then Qual score changes (higher or lower Qual score based upon 3rd party site “plays” and comments.

Module 548 analyzes the content quality over time. The PP system conducts periodic searches over the internet for copies of the content and ranks the copies of the content on third party sites. For example, the PP system may have information sharing agreements with third party websites wherein the visitor count and play time on third party websites is provided to the PP system. In this manner, the PP system can increase or decrease the payment score for a particular uploaded content based upon third party websites analysis. Further, if the uploaded content is authenticated by the third party website (see Cnt matching routines and programs, known to persons of ordinary skill in the art), the quality score and payment score changes based upon certain defined events and actions and characteristics.

C. Performance of the Content (e.g., Number Views, Comments, etc.).

Modules 550 to 568 relate to the performance of the content on the associated website (Act metric). In general, the performance of the content is the number of views (CPI) and the number of comments, the number of likes and dislikes and acclamations. Some of these CPI metrics are prior art systems.

However, the present invention provides deeper analysis of the performance of the content as specified below. As stated earlier, the modules 410 to 620 may be combined or altered or activated in any particular sequence or manner and combined with others. Efficiency concerns and targeted marketing may guide selection of one or more payment metrics and the processing of the metric formula or algorithm.

I. General Performance Stats Modules

Module 550: The Quant number of user-visitors who go to Cnt published web page (CPI).

Module 550 is essentially counting the quantity and number of visitors which see or view the uploaded content on the published web page. Typically, this is identified as CPI.

Module 552: The Quant number for Cnt based upon CPM, CPC and CPO.

Module 552 is the quantity or number of viewers for the uploaded content based upon CPM, CPC and CPO. As explained earlier, the CPM, CPC and CPO are know to persons of ordinary skill in the art.

Module 554: Velocity of views (CPI), acceleration of views

Module 554 involves a velocity of views for the visitors or viewers as well as the acceleration of views for the uploaded content. An increase in velocity of views normally results in an increase in payment score. A decrease in velocity views may result in a decrease of payment score.

Module 556: Thresholded CPM steps which increase (or decrease) the rev share paid to CP.

With respect to module 556, the number of views or CPI/CPM can be provided as Thresholded steps. When the number of views exceed certain threshold (set in the PP system), the payment score can be increased or decreased.

Module 558: Total gross value of the sales referral fees associated with Cnt. Fee cap for Cnt set by the sponsor advertiser. Total gross fees by sponsor advertiser for site. Cap on CPC fees, Cap on CPM fees. Cap on CPO fees. Cap on Sponsored Ad fees, referral fees, ad fees, subscriber fees.

Module 558 discusses the total gross value of the sales referral fees as well as any other revenue source fees discussed earlier. Those revenue source fees are advertising fees, sponsor ad fees, referral fees and user fees such as subscriber fees. The PP system may set a fee cap on the uploaded content. Otherwise, the sponsor advertiser may set the fee cap on the content. This ad cap is carried forward to the PP system. The PP processor should account for these fee caps. Additional, the sponsor may set a total gross fees available for the website having the uploaded content. This factor also needs to be included in the PP system. Continuing with the thresholding of increase or decrease on the payment score, there may be caps or threshold levels on the CPC fees, on the CPM fees and the COP fees.

Module 560: Money $ spent on Cnt by credit/debit card. Loyalty program web site parameters for Cnt.

Module 560 involves an analysis of the total amount of money allocated to the CP for the uploaded content based upon credit and debit card analysis. In other words, an analysis of viewers who used their credit or debit cards after they viewed the content has an effect on the value of the content on the associated website. Loyalty program parameters may also be monitored as part of this payment metric in module 560.

Module 562: CPI, CPM, CPC, CPO when Visitor goes to Cnt and stays on site and spends $ on site. Loyalty program web site parameters for Cnt.

Module 562 involves the use of CPI, CPM, CPC and CPO when the user or visitor views the content and stays on the associated website which publishes the content. If the user stays on the associated website and spends money on that website or on a referred to website, the value of the content should be increased. Loyalty programs may also be included in this module.

Module 564: Ad revenue for Cnt. Ad rev for CP. Ad rev for site.

Module 564 analyzes ad revenue for the content. The ad revenue could be based upon the content provider CP or may be based upon the website which publishes the content.

Module 566: Source of money to be paid to CP. Source: sponsored advertisers, CPO, referral fees from 3^{rd} Pty sites based upon view of Cnt on site.

Module 566 involves an analysis of the source of money to be paid to the CP. One payment score can be assigned to sponsored advertisers, another payment score assigned to CPO, a third for referral fees, a fourth score assigned to referral from third party websites to the associated website holding the uploaded content. All of these data metrics can be based upon the number of use on the uploaded content on the associated website.

Module 568: Money to be paid by SysOp for referral fees to 3^{rd} Pty sites based upon view of Cnt on site.

Module 568 involves an analysis of the money to be paid by the system operator for referral fees to third party websites based upon the views of the uploaded content on the associated website. In other words, the associated website may be required to pay referral fees to other third party websites. If a viewer is referred to the associated website from a third party website and then views the uploaded content, this may be a negative payment score for the uploaded content since the PP system has to pay referral fees to the third party referring website.

II. Upgrade and Reset Performance Stats Modules

Modules 570 to 576 involves upgrading the performance of the content metric and resetting the performance statistics.

Module 570: Repeat “Critical Acclaim—Response” in Content Module

Module 570 repeats the critical acclaim and response module in the content module. Module 570 repeats the critical acclaim—response and the content centric module, that is, modules 510 to 512.

Module 572: Repeat “Subject Analysis” in Content Module

Module 572 repeats the subject analysis in the content centric section. This content centric analysis is discussed earlier in connection with modules 514 to 522.

Module 574: Repeat “Relation to 3^{rd} Pty Materials” in Content Module

Module 574 repeats the relation to third party materials in the content centric section. This is a repeat effectively of modules 524 to 532.

Module 576: Repeat “Performance Factors” in Content Module

Module 576 repeats the performance factors in the content centric section. That is, modules 534 to 548.

D. Viewer-Visitor Centric Modules.

Modules 578 to 620 analyze and obtain data metrics for the viewers or visitors to the uploaded content.

Module 578: Visitor as a Viewer of Cnt. Acquire Viewer UPP data if any. If UPP found, assign Viewer Qual score based upon CP/UPP-User data.

Module 578 analyzes who is the viewer of the uploaded content (a Char metric on a single visitor, an Act metric on multiple visitors). The PP system acquires the viewer UPP if the viewer has registered with the PP system. Also, if the viewer has not uploaded his or her own data (no specific UPP), the PP system may have a basic internet protocol UPP identifier data for that viewer (a V-id). This can be confirmed by using items and data from the ad network. If the stored UPP is found for the viewer, a viewer quality score is assigned to the then-current viewer when the viewer sees or hears the uploaded content.

Module 580: Obtain Viewer information from current data extracted from Viewer device to create a temporary or transient visitor identification “V-id.” V-id obtained from Viewer browser history, device data, cookie list from device, referral source, and Viewer data obtained from 3rd Pty sources, such as the ad networks. Once Sys id's the Viewer (using cookies, browser-history and checking with 3rd Pty sites), Sys determines Viewer value or Qual score. A high value viewer V-id-V-Qual score could be assigned to Lady Gaga as a Viewer.

Module 580 obtains the viewer information from current extracted from the viewer's device to create a shadow visitor identification or V-id. The V-id is obtained from the viewer browser history, device data, cookie list from the device, referral source information from third party referring websites, and viewer data obtained from third party sources such as ad networks. Once the PP system identifies the viewer by using cookies, browser history and checking with third party sites in the ad network, the PP system determines whether the viewer should be assigned a high value viewer quality score or a low value score.

A high value viewer quality score can be assigned to certain well know personality such as Lady Gaga. In other words, if Lady Gaga views content on an associated website, that content should have a higher payment score compared to other content. The V-id falls within a group—viewer value parameter. See discussions about Rolling Stone magazine™ writer and group values and parameters.

Module 582: Viewer meets a predetermined user-visitor group profile (e.g., any posting from the Rolling Stones magazine). V-id-Grp, V-id-Grp-Qual score

Module 582 involves a viewer that meets a predetermined user visitor profile group. For example, if a viewer is automatically identified by various search engine results or other information as being a writer for Rolling Stones magazine™, then that viewer fitting within the viewer visitor group profile is given a higher quality score. When that person of higher quality score sees the uploaded content, the payment score is increased. In a like manner, if the viewer group is a negative group, such as a white supremacist group, the payment score can be reduced if that viewer meets or matches a negative group profile views or remains on site at the uploaded content.

Module 584: Viewer with high Qual group profile. Viewer with high Qual group profile (number of followers on twitter for Viewer). CCT Viewer data with UPP data to id Viewer as part of Qual group profile.

Module 584 involves a viewer with a high quality group profile which is determined based upon the number of followers for that viewer on twitter or search engine results or any other ranking available from other internet sites. The twitter following for a particular viewer may be analyzed by CCT analysis in order to increase or decrease the viewer quality score. This is done automatically by the PP system.

Module 586: Referral source from Viewer. A user referred by a well connected referral source increases the content value. See V-id-Refer

Module 586 analyzes the referral source for a particular viewer who is looking at (viewing) the uploaded content. If the user-visitor has been referred by a well established third party referral source website, this increases the value of the content. Module 590 uses the data metric from modules 578 to 586 and then assigns a viewer identification quality score to the particular viewer id or V-id. The PP system may utilize all or some of the above noted elements to ascertain the quality of a V-id (and hence the payment metric). Further, the PP system may utilize some derivative or algorithm to ascertain a CP or a registered user UPP quality score and reset that same or alter that score to a V-id quality—payment score. The V-id quality score is used in conjunction with follow-on data metrics in modules 592 to 596.

Module 590: Once Module factors 578-586 determined, Sys assigns V-id-V-Qual to the V-id (maybe the V-id is the CP/UPP-User Qual score, or a derivative thereof). For patent specification logic processing reasons, the CP/UPP-User Qual score is set as the V-id-V-Qual. However, the Sys may take a derivative of the CP/UPP-User Qual score and reset it as a V-id-V-Qual score for the CP/UPP-User. Use V-id-V-Qual score with follow-on data in Modules 592-596.

Once the PP system uses module 578-587, then the PP system can assign a payment score to the then-current viewer of the Cnt. Therefore, the PP system uses a CP-UPP metric for the then-current viewer of the Cnt, a registered User-UPP for the then-current viewer of the Cnt and the V-id for the then-current viewer of the Cnt.

Module 592: Aggregate t on Sys site: V-id-t-Site-Total-Time,

Module 592 aggregates the time on the associated website for a particular visitor and stores that same as a payment score metric. Time on website is different than time on Cnt. These are Act metrics.

Module 593: Aggregate t for all visits on specific Cnt: V-id-CntDateCode-Total-Time

Module 593 aggregates time for all visits and all visitors (viewers) on a specific uploaded content and assigns a payment score. The score depends upon the UPP and the V-id value.

Module 594: current t on specific Cnt: V-id-CntDateCode-Vdate-Time-Now,

Module 594 analyzes a current time spent on a specific uploaded content (Cnt stickiness, see also website stickiness). This time on content is an indication of viewer interest. Since the PP system knows the value of the visitor with the V-id and/or UPP quality score, more time spent on uploaded content by a high quality V-id/UPP increments the payment score.

Module 595: V-id (includes CP/UPP-User) returns to site: V-id-Site-Returns

Module 595 determines whether the visitor with a high or low V-id (this metric includes CP/UPP; User-UPP) returns to the associated website. The number of returns to the website is also an indicator of the quality and monetary value of the uploaded content. Returns, rate of returns and acceleration factors increase and decrease payment scores.

Module 596: V-id (includes CP/UPP-User) returns to specific Cnt: V-id-CntDateCode-Returns

Module 596 correlates the V-id quality score to a specific uploaded content and the returns to a specific uploaded content. Therefore, module 595 analyzes returns to the website whereas module 596 analyzes returns to the uploaded content.

Module 612: First Time Cnt posted by UPP-User, repeat metrics Module 592 to 596 for First Time “New-CP”

Module 612 analyzes whether the uploaded content is the first content uploaded by a particular registered user. The metrics from modules 592 to 596 are repeated and incremented for this new content provider. This first-posting bump is an incentive for prospective CPs.

Module 614: Unit time Quant. The V-id time units on specific Cnt (amount of time units visitor in on the Cnt page, for example number of times the V-id spends 10 sec on Cnt, “10 sec” time units). This generates CntDateCode-Vdate-Time-Units, metric on a per V-id basis. Also metric on the aggregate during time window, metric on aggregate all V-id (includes CP or UPP-Users).

Module 614 provides a unit time quantity (how many viewers stay on Cnt for more than 10 sec time blocks) for the uploaded content. In other words, the PP system may want the number of viewers who spend more than 10 sec. viewing a particular uploaded content (a nominal view period, set by PP system and Sys Op). The 10 sec. time period is the unitized time period. The PP system measures the number of viewers who spend 10 sec. or longer on the uploaded content. This indicates the stickiness or viewer interest on that particular uploaded content.

Module 616: Mean and average time Quant: t factor per V-id (the longer time V-id stay on the specific Cnt page the higher quality Cnt-Qual score), see Time-Ave-Quant-CntDateCode, calc mean time-on-Cnt, average time-on-Cnt, aggregate all V-id time during time windows, aggregate all V-id time on specific Cnt for all time.

Module 616 also includes aggregate measurements of unitized time on the uploaded content during a particular time windows. These time windows could be 24 hrs, 1 week, 1 month etc.

Also Module 616 provides mean, average, median time spent viewing uploaded content. The longer viewer spend on particular uploaded content, the higher the quality of the content (higher Cnt Qual score) and the higher payment score. The PP system calculates the mean time on the content, the average time on the content, the aggregate of all V-id or visitor time during certain time windows, and all visitor time on specific content for all time.

Module 618: Return to Site metrics: Frequency of V-id return to specific Cnt published web page; velocity of returns; returns to site after visit to specific Cnt, returns to site from another 3^{rd} Pty website, metric on a per V-id basis, aggregate all V-id returns for all time, for time windows.

Module 618 is the return to website metrics. Return to website is an important consideration in valuing content. Therefore, module 616 obtains a data metric for the frequency of visitor return to a specific uploaded content. The velocity of returns, the returns to the associated website after the visit to a specific content, return to the website from another third party referring website is factored in as part of the payment score. A metric is obtained based upon a per visitor basis. Further, the aggregate of all visitor returns for all time and a visitor return over certain predetermined windows is a payment factor. When this performance metric decreases, the payment score decreases.

Module 620: Type and Quan of “shares” for Cnt from and to 3rd party sites by V-id, email shares, social ntwk shares, share velocity, share Quant for certain time windows, share Quant for “all time”, metrics per V-id, metrics for all V-ids over certain time windows, metric on aggregates for all V-ids for all time.

With respect to module 620, the type and quantity of shares associated with uploaded content to and from third party websites is analyzed. The visitor quality factor is integrated with that visitor score for email shares, social network shares, and share by other visitors. The share velocity is a data metric in addition with the number of shares for certain time windows. The PP system also captures the quantity for all time shares and the metrics on a per visitor basis as well as the metrics on a per group visitor basis. A metric on views by a certain group of targeted viewers may be important for sponsored ads and advertisers.

### Time Factors

First pmt calc on a prospective basis when the Cnt is uploaded (or temp upload, with a pint estimator), and pmt re-calc based upon actual views V-quant over a predetermined period of time (for example, a one (1) month period) (window t) or V-quant exceeds pre-set value, or upon CP rqt. Otherwise, pmt calc at preset t times, e.g. 24 hrs post upload, I week post upload, then monthly. Pmt re-calc upon CP rqt. Trigger pmt re-calc based upon exterior factors: topic trending, relevance, search engine recognition above a preset value, content, context and taxonomic (“CCT”) relevance key words in 3^{rd} Pty sources, CCT on descriptors. The content provider payment formula may include all or a portion of these factors.

### Flow Charts and System Diagrams

Returning to FIG. 1, the payment processor has several functional blocks which are generally identified as: the UPP or content provider CP centric actions and characteristics function block 12, the Content centric characteristics and actions function block 14; the Performance centric actions and characteristics function block 16, and the Viewer centric actions and characteristics function block 18.

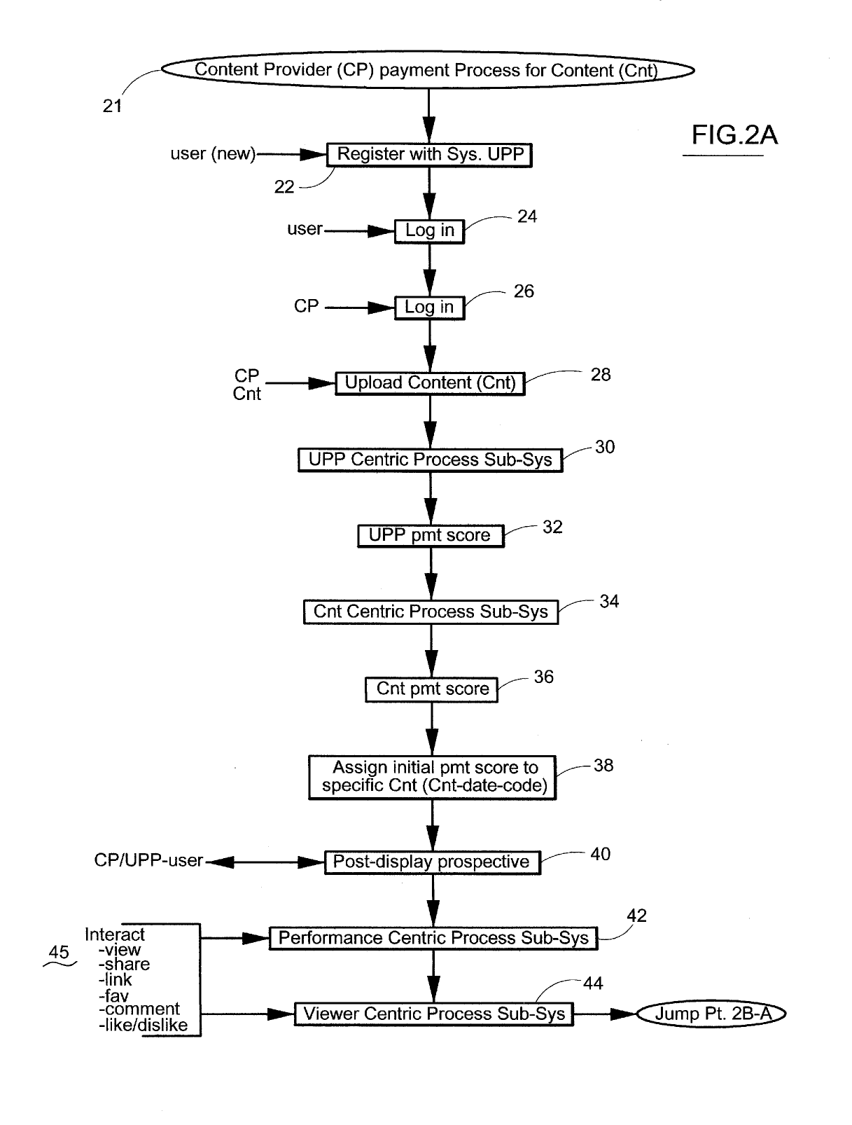

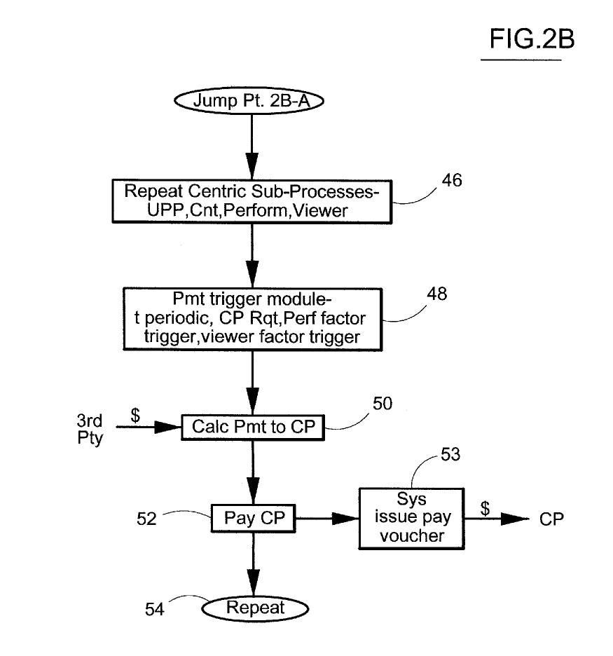

FIGS. 2A and 2B diagrammatically illustrate various functional elements of the content provider CP payment process for uploaded content Cnt. In step 22, the user registers with the PP system and populates the user's UPP. This may involve manual input of data by the user or a semi-manual operation by the User authorizing a copy over command from another site or an automated population routine of profile data by the PP system, as authorized by the user. Later, after the user has completed the UPP, the user logs in to the PP system in step 24. If the User with a UPP then provides content, he or she is a CP.

In step 26, the content provider CP logs into the system. Of course, if the registered user has earlier supplied content to the PP system, that registered user is classified as a “content provider” CP as discussed earlier herein.

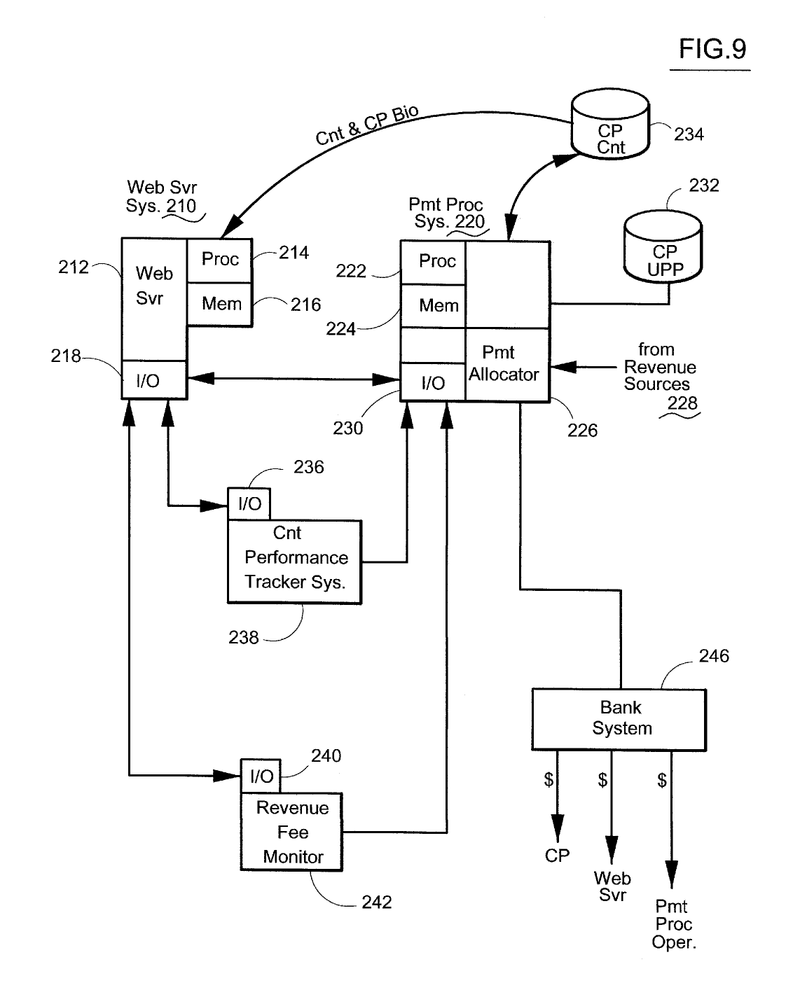

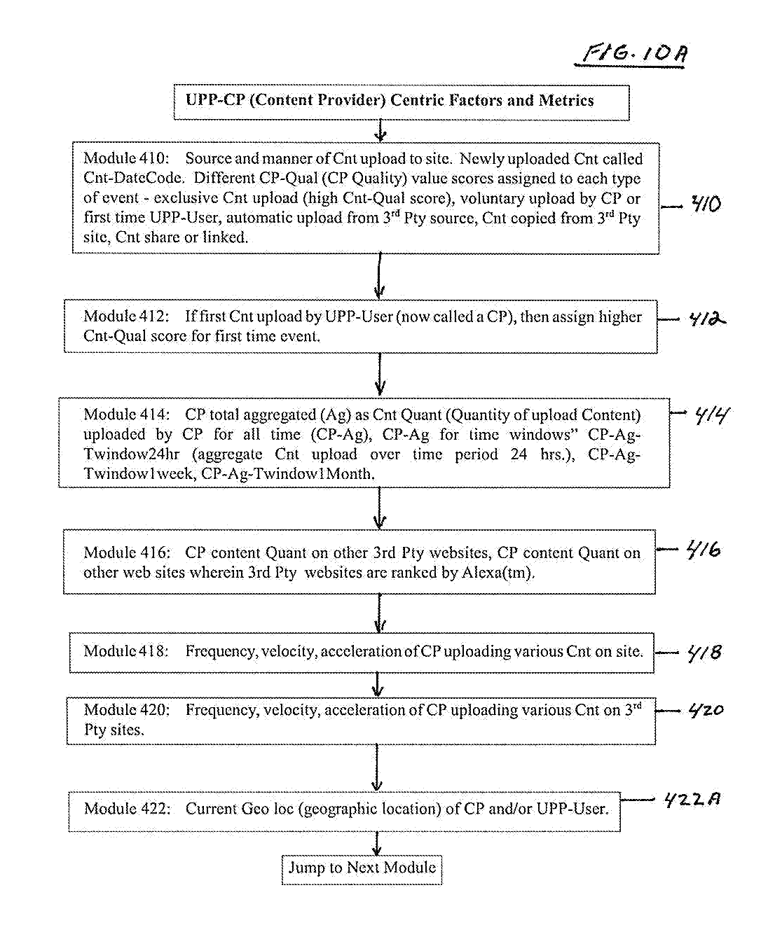

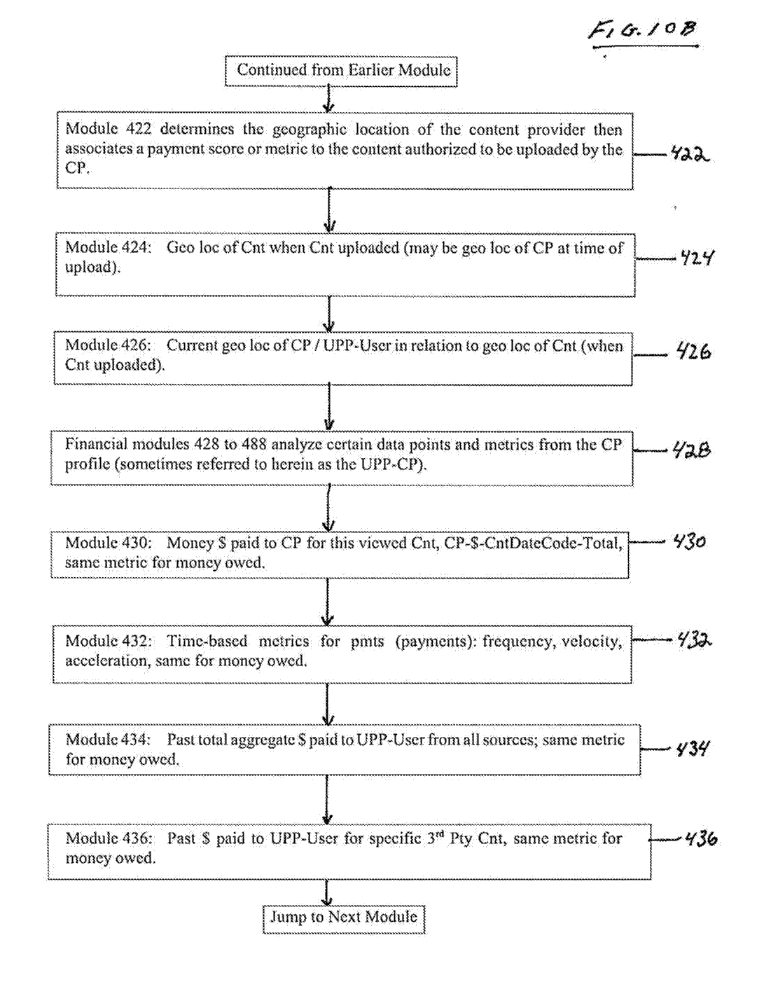

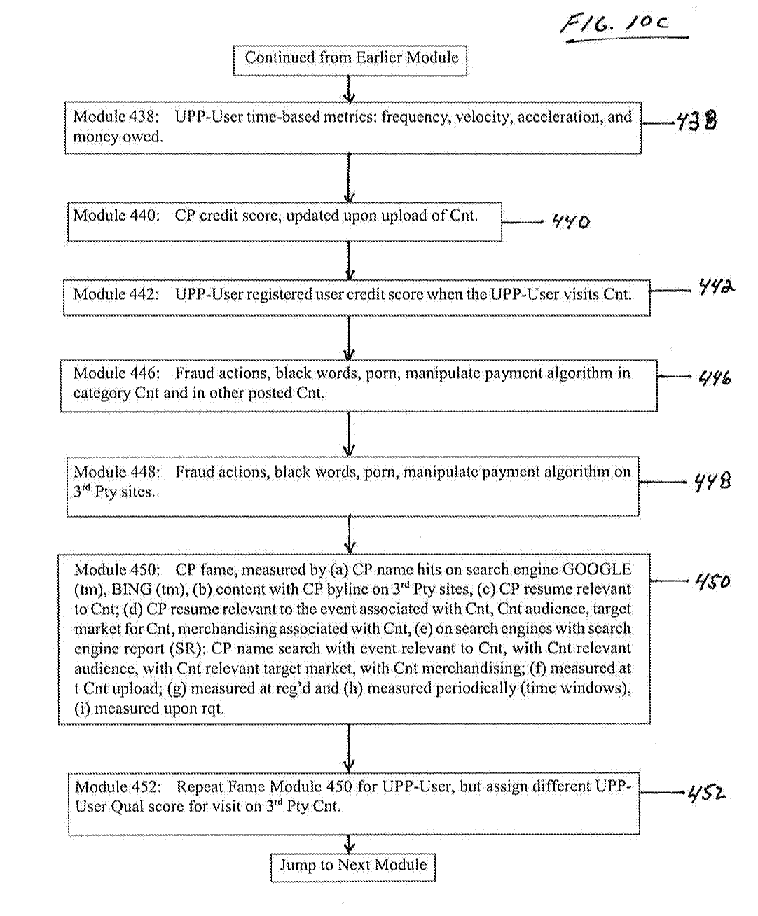

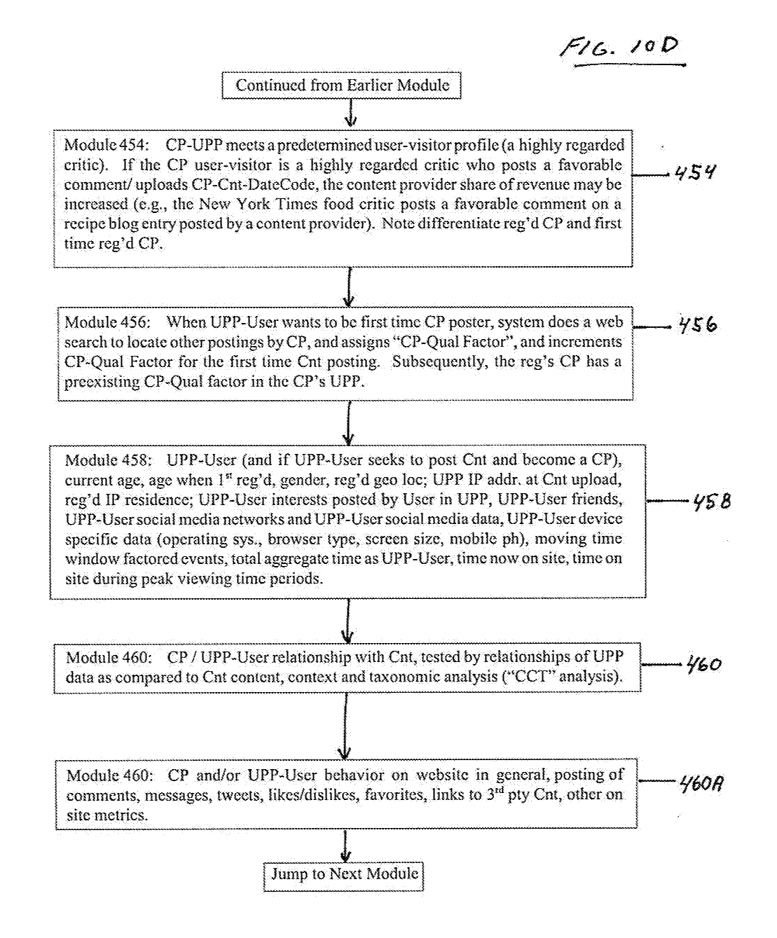

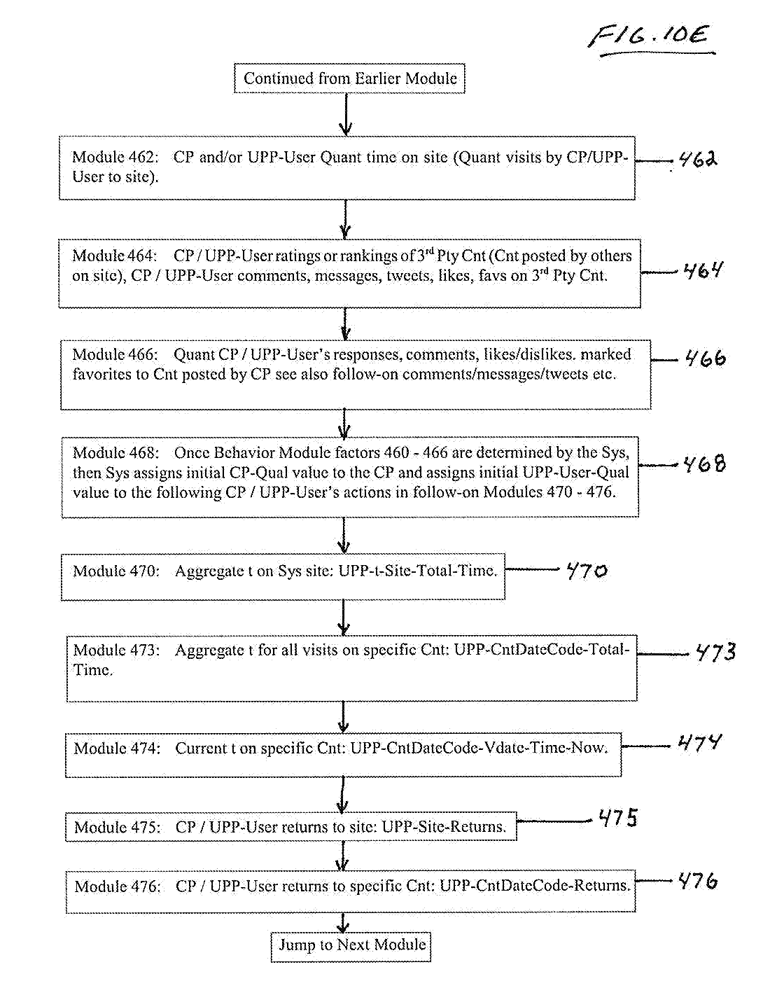

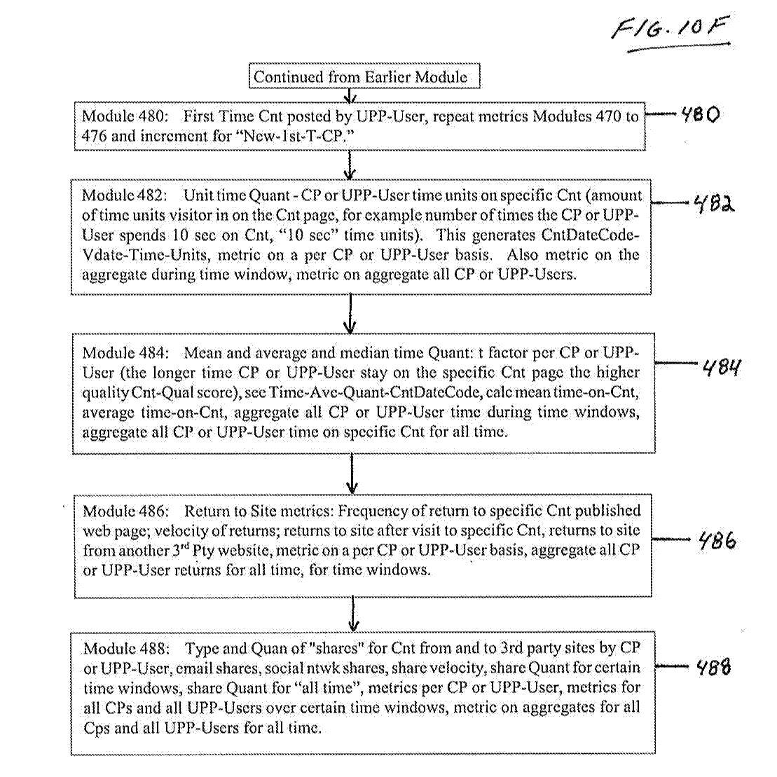

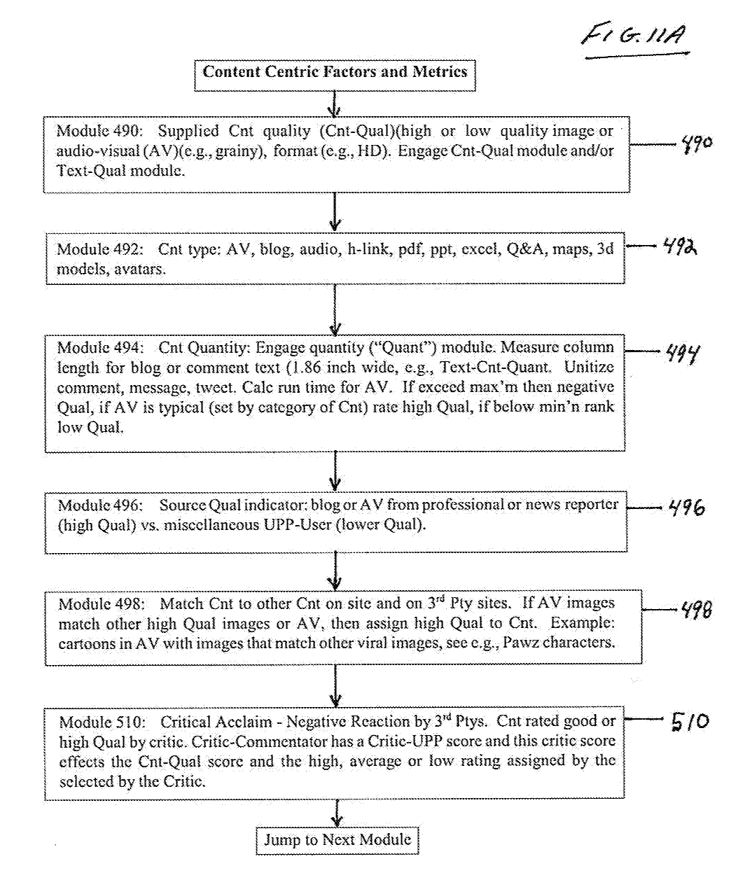

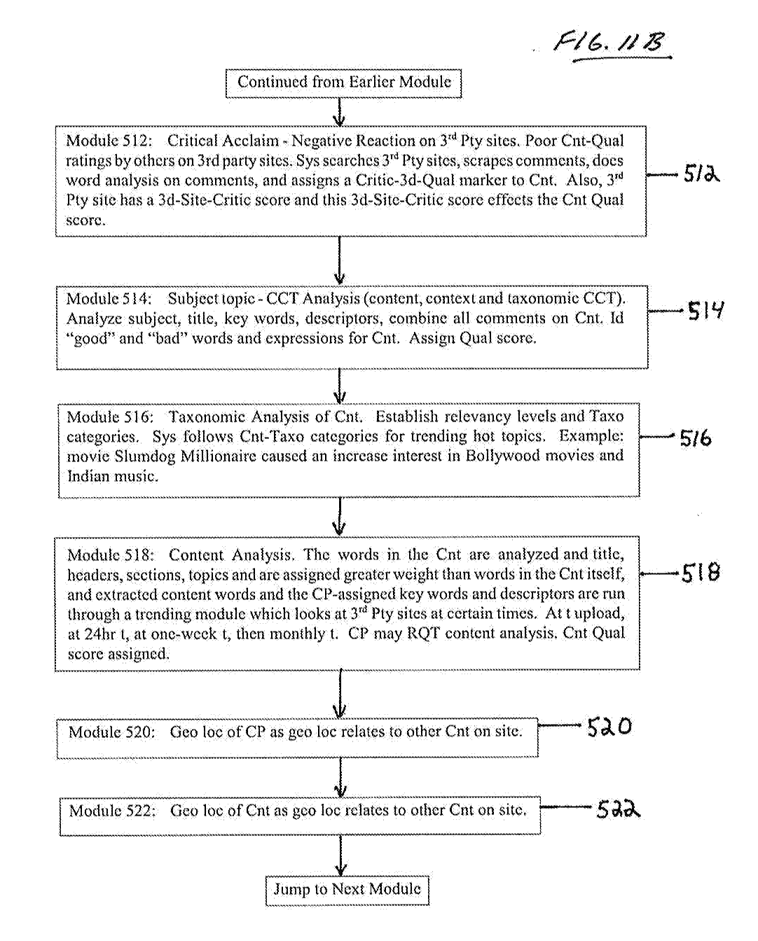

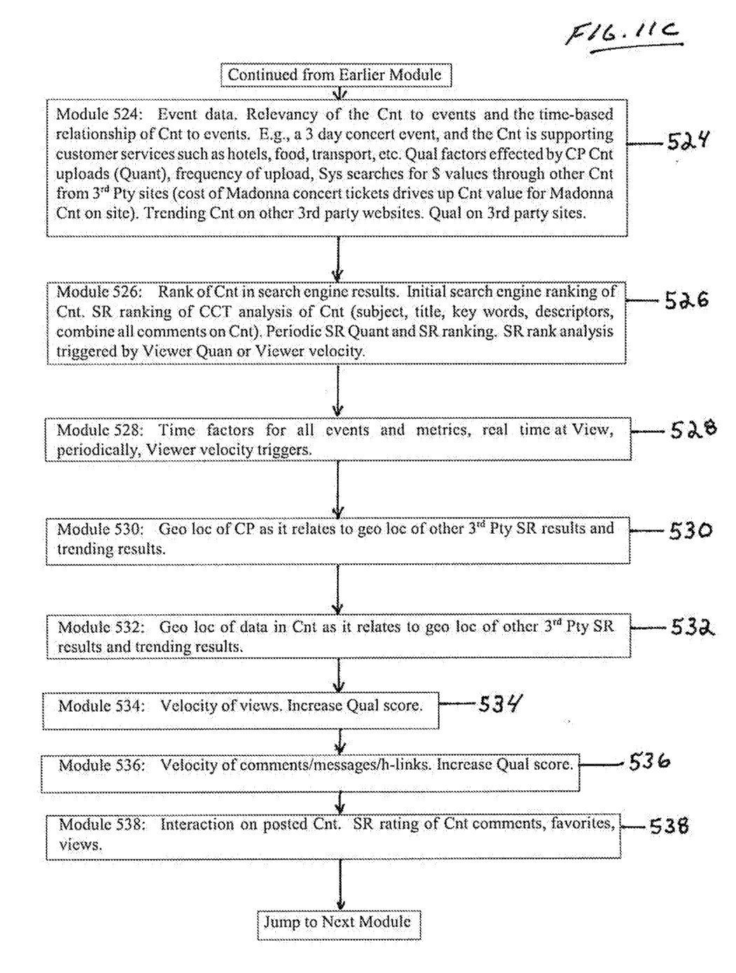

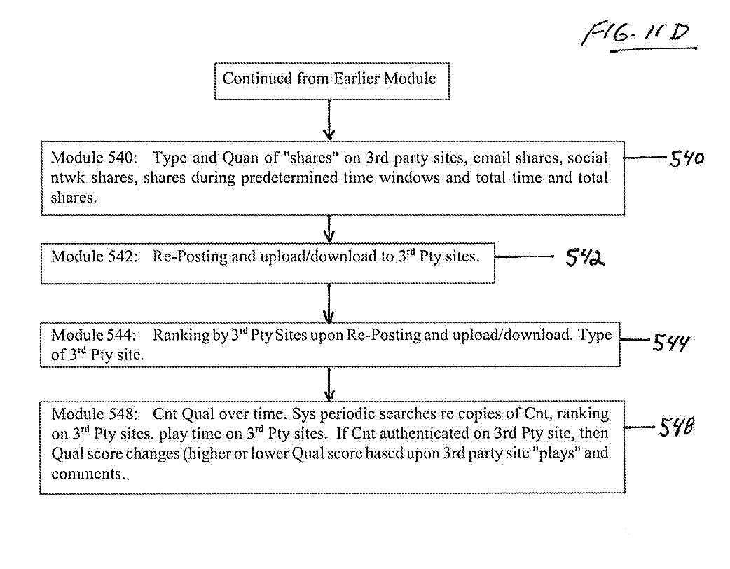

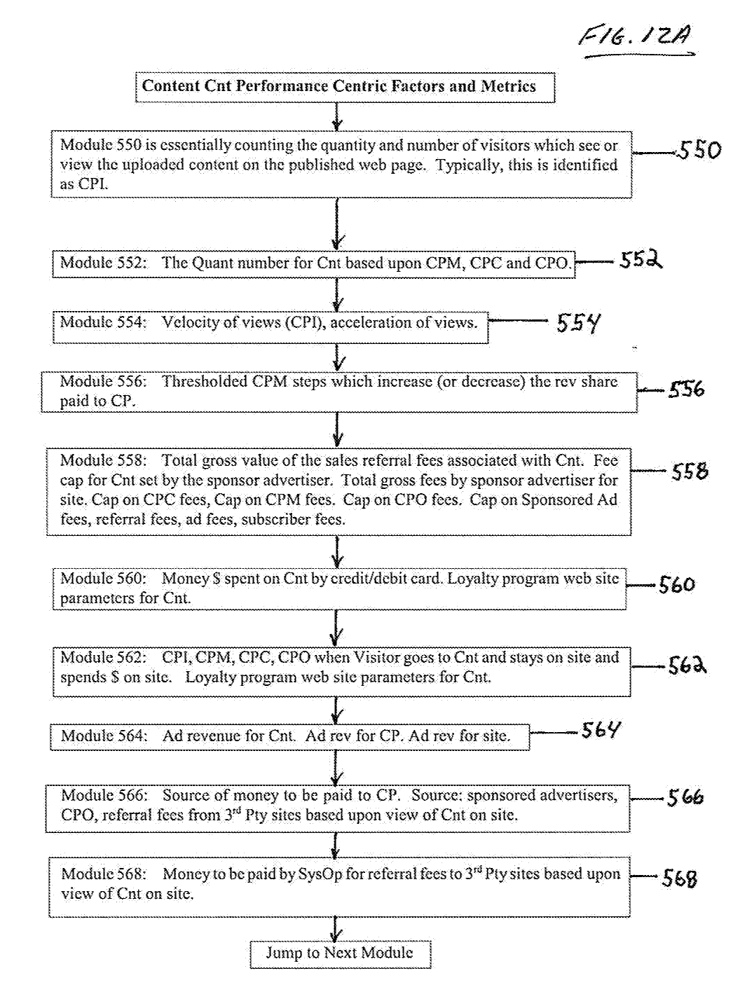

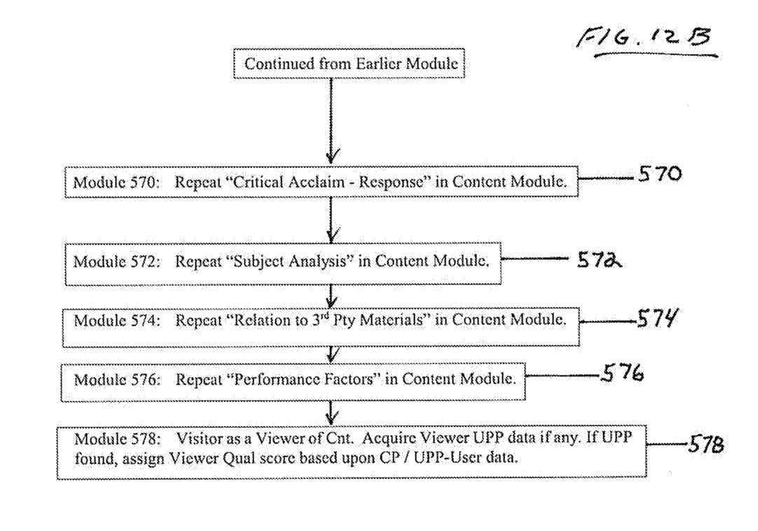

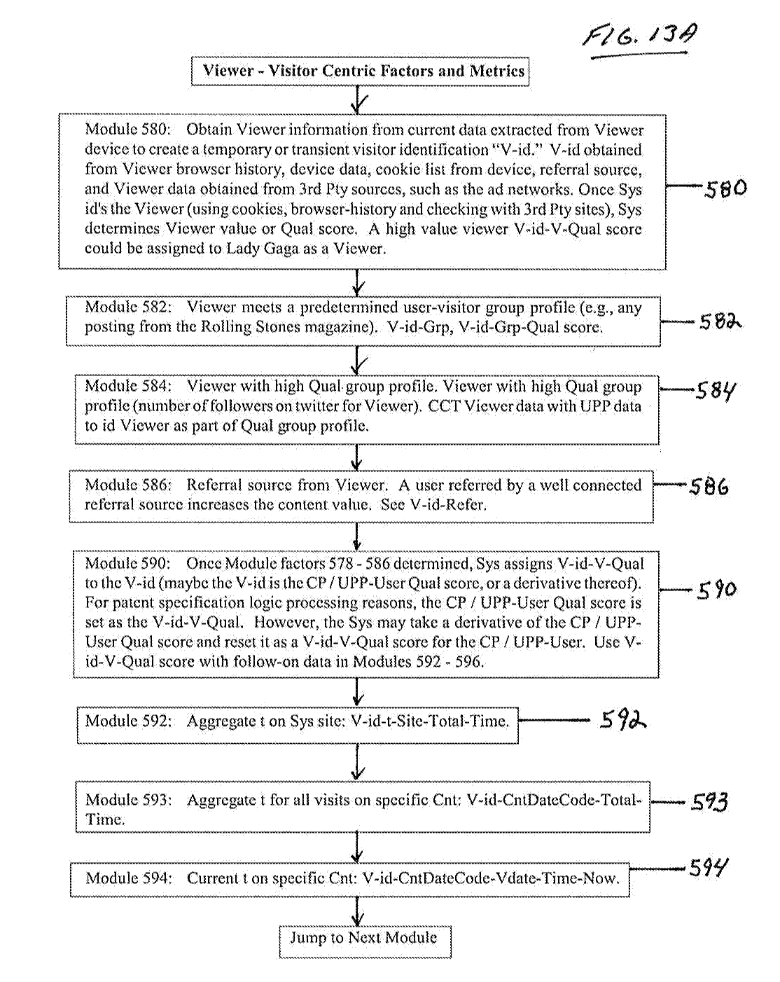

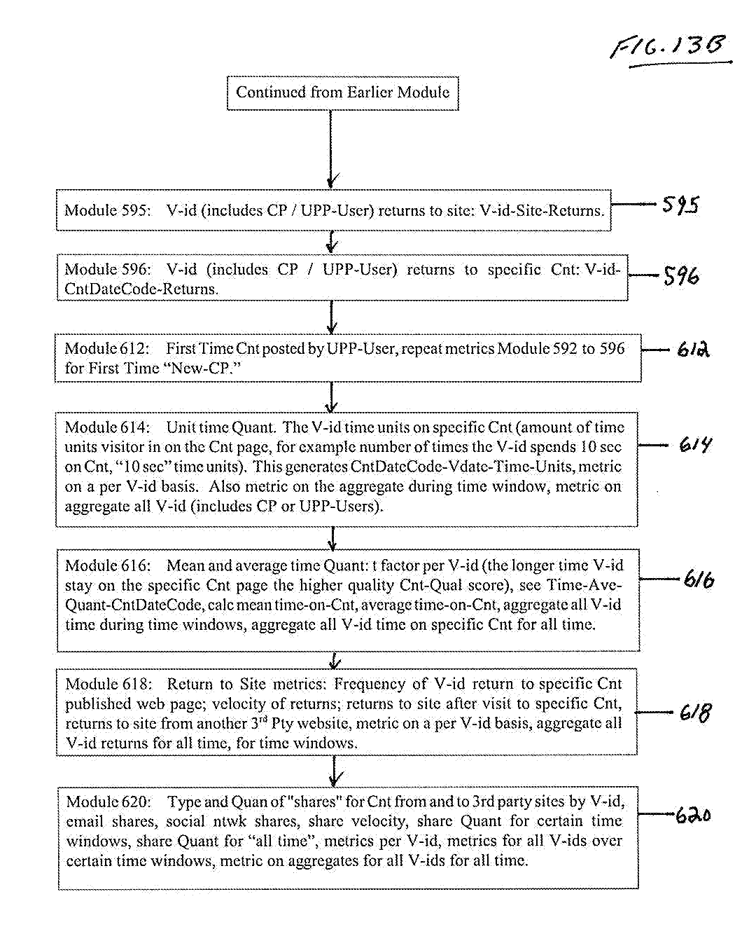

In step 28, the CP uploads content Cnt to the PP system. This upload function may involve the manual upload of digital data from the CP or may involve an authorization by the CP that the PP system can go to a third party website and copy or scrape the content from that third party website. In any event, the content is uploaded and processed in some manner, shape or form by the PP system. The processing by the PP system may be no more than transferring a link to an associated website and the associated website would then gather the content in an independent operation from the Cnt source. In that situation, a distributed computer system is utilized and the upload function is authorized by the PP system but actually carried out by the associated web processor. See FIG. 9.

In step 30, the PP system engages the UPP-CP centric process sub-system. As discussed earlier, the registered user that has provided content is then classified as a content provider. Therefore, block 30 is the CP centric process. In step 32, the PP system generates a payment score based upon the UPP-CP centric process. See Modules listed above. In step 34, a Content centric process is engaged. As discussed earlier, the centric processes may utilize one or more of the various data metrics and processes discussed above in connection with modules 410 to 620.

In step 36, the PP system generates a payment score for the Content centric process. In step 38, the PP system assigns an initial payment score to the specific content. The purpose of this temporary assignment is to inform the content provider of the possibility of an economic or monetization of the uploaded content. In some situations, the PP system may gather and accept the content and hold the content in a data store (or DB) prior to publishing the Cnt on the associated website and may conduct some of the data metrics discussed above in connection with modules 410 to 620. After doing this initial investigation and data processing, the PP system could inform the CP of the potential monetization of that content. The payment score may be displayed or ranges of payouts based upon CPM or revenue projections may be displayed.

In step 40, the PP system displays to the CP a prospective money return for that content. Either estimated payments or a payment score (within a range of payments) may be displayed to the CP or prospective CP.

In step 42, the PP system activates the Performance centric processes. In step 44, the system obtains Viewer centric process data. Inputs collectively shown as item 45 include interaction with the posted or published content which include viewing, sharing the content, linking to the content and linking from the content, citing the content as a favorite, comments placed on the content and acclamations such as likes, dislikes number of stars etc.

FIG. 2B is connected to FIG. 2A by jump point 2B-A. Function step 46 repeats the various centric sub processes noted above in steps 30, 34, 42, and 44. Step 48 is the trigger payment module. The trigger payment occurs periodically or upon CP request. Sometimes, the PP system will not engage in a payment event upon a CP request dependant upon system parameters established by the Sys Op of the PP system. For example, a viewer threshold has not been exceeded or a time period has not been passed.

In other situations, the CP may request an updated payment schedule from the PP processor. Therefor, the CP can request an update of the potential monetization of the content in the PP processor system. Then, the PP system will engage in the analysis discussed above in modules 410-620 or any combination thereof. More importantly, the CP may request a performance factor review. Otherwise, the system in step 48 engages its own performance factor review based upon certain levels or thresholds being met by the performance analysis as noted above in step function 42. Viewer thresholds can result in a recalculation of the payment score. The viewer threshold could be met as calculated by the PP system in the Viewer centric process function 44 above. Other Cnt performance thresholds may trigger re-calculation of the payment score.

In step 50, the PP system calculates the payment to the content provider. Money is obtained from various revenue sources including advertising fees, sponsored ad fees, referral fees and user or subscriber fees to the associated website. Other revenue sources may be use to pay the CP his or her allocated fee. All revenue sources fall within the scope of this invention. These revenue fees are indicated by the third party $ input into function step block 50. In step 52, the PP system pays the CP or facilitates payment by activating the appropriate action in and through a banking system. See FIG. 9 for the banking system.

In step 53, the PP system issues a payment voucher and money is eventually sent to the content provider via the banking system. Step 54 repeats the overall payment metric processes as indicated in process routine 21 in FIG. 2A.

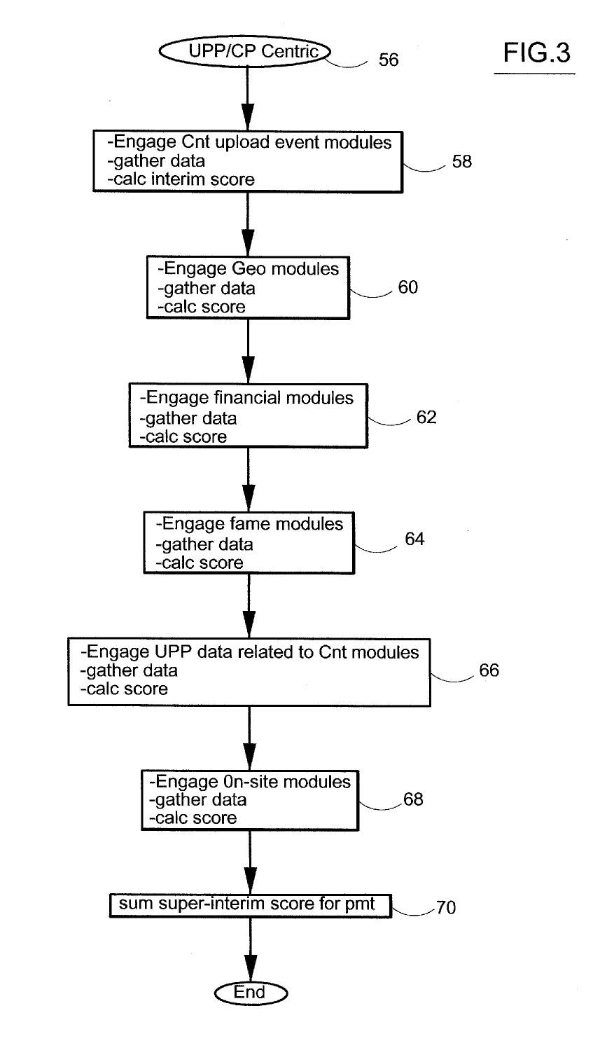

FIG. 3 diagrammatically illustrates various high level functions for the User-UPP and CP centric process. The routine 56 begins at function step 58 where the system engages the content upload event module. The system gathers data and processes that data and calculates an interim payment score. In step 60, the system engages the geographic modules, gathers the data and calculates a further interim payment score. In step 62, the system engages the financial modules, gathers the data and calculates a further interim payment score. In step 64, the system engages the fame modules discussed above, gathers the data and calculates another payment score. In step 66, the system engages the UPP data related to the content modules, gathers the data and calculates another payment score. In step 68, the system engages the on-site modules, gathers the data and calculates another payment score. In step 70, the system sums these payment scores or creates a super-interim score for payment allocation.

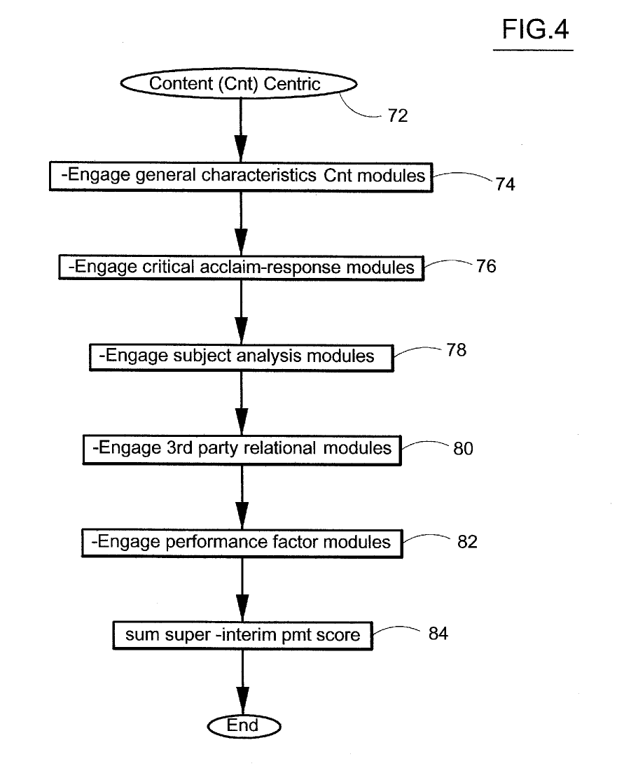

FIG. 4 diagrammatically illustrates a flowchart and functional system diagram for the Content centric routine 72. In step 74, the system engages the general characteristic analysis for the content modules. These are discussed above in connection with modules 410 to 620. In step 76, the system engages and executes the critical acclaim and response modules. In step 78, the system engages the subject analysis modules. In step 80, the system engages the third party relational modules for the content. A relationship routine and program is discussed later. In step 82, the system engages the performance factor modules for the uploaded content. In step 84, the system sums or places into an algorithm the metrics to provide a second super-interim payment score.

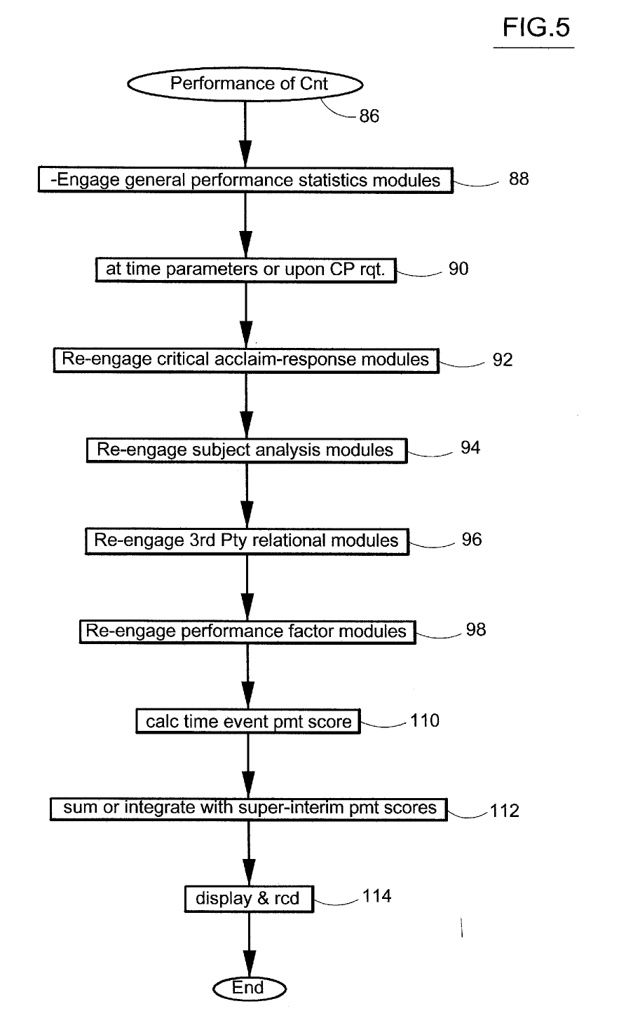

FIG. 5 is a functional flowchart diagram showing the performance of content analysis routine 86. In step 88, the system engages the general performance and quality statistic modules discussed above in modules 410-620. In step 90, the system engages time parameters that recalculates the performance. Otherwise, or optionally, the CP can request that the performance parameters be reviewed and updated by the PP system and that the payment score be revised. Step 92 re-engages the critical acclaim and response modules. This re-engagement can be time based (automatic) or time window based or automatically triggered based on other events such as viewers responses, comments etc. Step 94 re-engages the subject and analysis modules. Step 96 re-engages the third party relational modules. Step 98 re-engages the performance factor modules. Step 110 calculates the time event payment score. In other words, at certain times, the payment scores are revised. Step 112 sums or integrates these various payment scores with the super-interim payment scores. Step 114 displays the payment scores to the content provider and records them into the UPP of the CP.

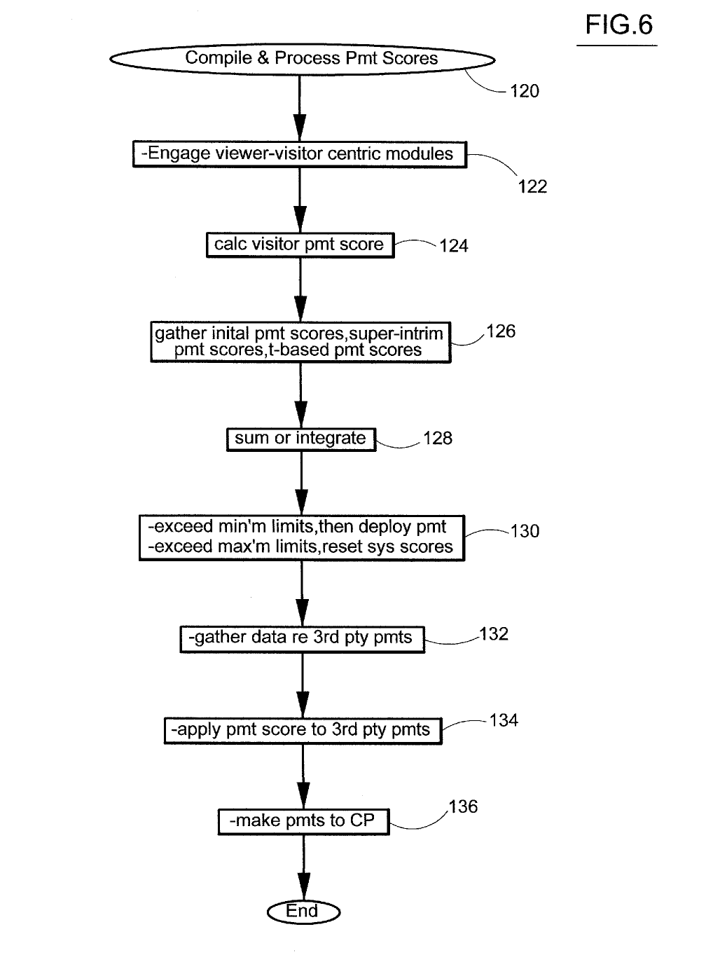

FIG. 6 compiles and processes the various payment scores as routine or program 120. In step 122, the system engages the viewer or visitor centric modules discussed above. In step 124, the system calculates the visitor payment score. In step 126, the system gathers the initial payment scores, the super-interim payment scores and the time based payment scores. In step 128, the system sums these scores or integrates the scores together in a predetermined algorithm as proposed by the Sys Op and set into the PP system. In step 130, the PP system determines whether minimum limits have been exceeded and, if so, engages the payment process, that is, engages instruction to the banking system to pay the CP.

Step 130 also determines whether the maximum limits have been reached by CP payments. In this situation, the PP system may reset the scoring level to a more realistic monetization of the uploaded content. In step 132, the system gathers data regarding third party payments. These third party payments are effectively obtained from revenue source fees. In step 134, the system applies the payment score to third party payments to calculate the allocation to the CP. All of the revenue source fees may be paid to the CP or portions (allocations) of those fees may be paid to the CP. In step 136, payment is made to the CP either directly from the PP system or through a banking system.

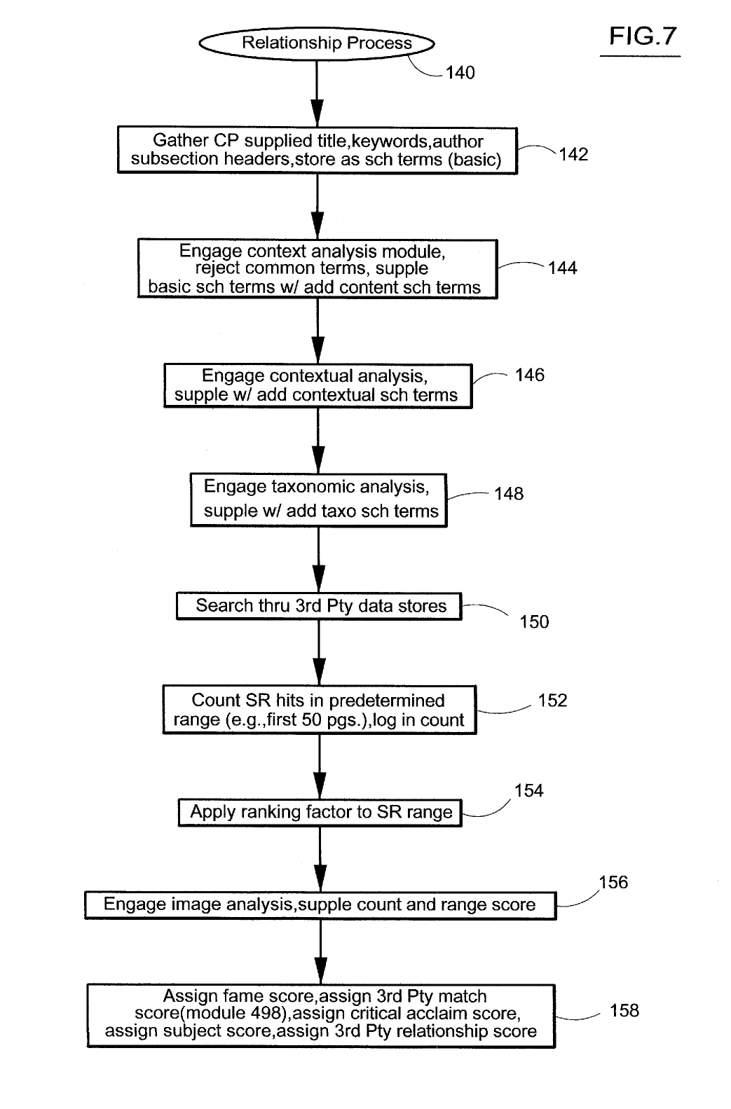

FIG. 7 diagrammatically illustrates the relationship process in relating either content proposed to be uploaded or uploaded content to various other items. Process 140 begins in step 142 wherein the CP supplies the title, keywords, author subsections heading and the PP system stores these terms as search terms. Otherwise, the PP system could extract these titles, keywords and other data from the content as an automatic function. In step 144, the PP system engages a contextual analysis by rejecting common terms and identifying important terms. Supplemental basic search terms may be located and obtained based on antonyms and synonyms of the key terms. These additional content search terms would be used in step 146.

In step 146, the PP system engages in a contextual analysis and supplements the search terms with additional contextual search terms. In step 148, the system engages in a taxonomic analysis and supplements the search terms with taxonomic search terms. The CCT analysis is known by persons of ordinary skill in the art. However, applying the CCT analysis to a CP payment system is not known.

In step 150, the PP system searches through third party databases and data stores. In step 152, the PP system counts the search results hits in a predetermined range. For example, the number of similar hits for the search term of the first 50 pgs from the search results. The system logs in the hit count in step 152. In step 154, the system applies a ranking factor to the search result range. If the search term is highly relevant and appears in the first 10 SR results, this is ranked higher than otherwise. In step 156, the PP system engages in an image analysis and supplements the counts and range score obtained earlier in step 152, 154.

In step 158, the system assigns a fame score to the content, assigns a third party match score (see module 498), and assigns critical acclaim scores as well as assigns subject scores and assigns a third party relationship scores to the uploaded content. Rather than payment scores, the PP system may use a module scoring system. The CCT analysis can be used on this related, follow-on content.

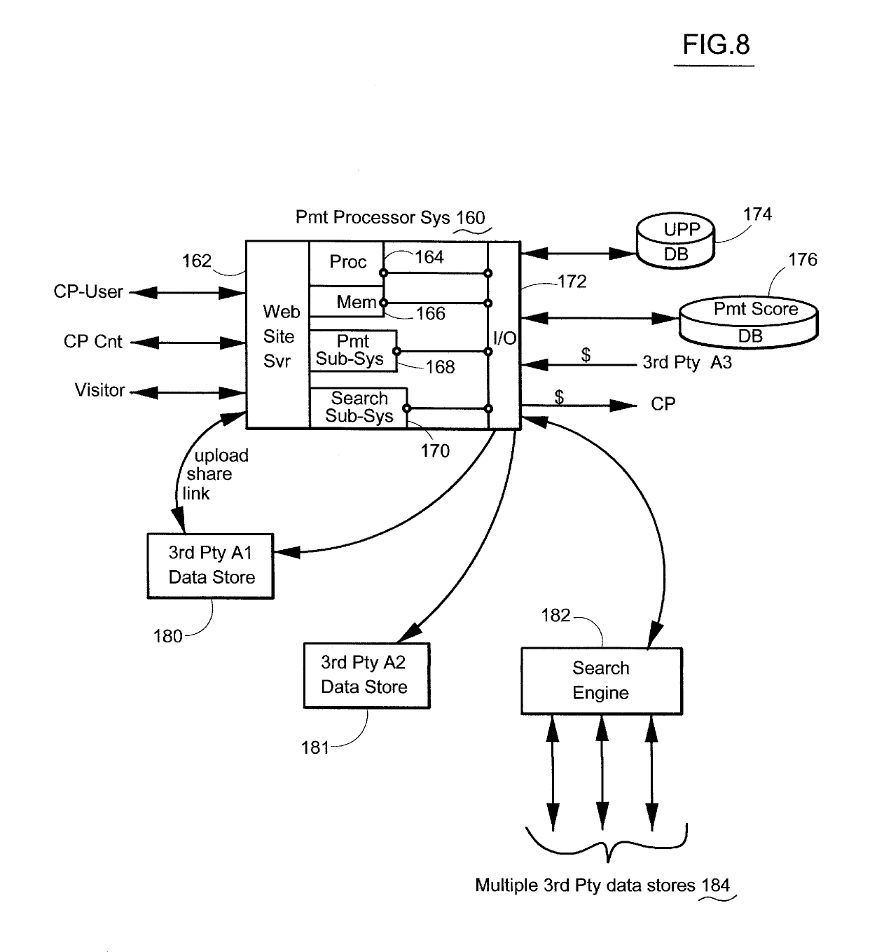

FIG. 8 diagrammatically illustrates a centralized computer system for the payment processing system. FIG. 9 generally illustrates a distributed system.

FIG. 8 shows payment processing system 160 which includes website server module 162. The CP and registered users interact with the associated website server 162. The CP uploads content into the website server 162. Visitors view the uploaded content on the website server 162. Payment processor 160 includes processor unit 164, digital memory store 166 (databases, RAM, ROM, server memories, etc), a payment sub-system module 168, and a search sub-system module 170. Payment processor 160 also includes input/output module 172. The input/output module operates in conjunction with UPP/CP database 174. The UPP dB could be any type of data store, that is, it is not necessarily as database but rather a data storage memory unit.

A payment score database 176 is also used. As is known, databases 174, 176 may be combined to a single database or may be split up and subdivided into multiple memory sections dependent upon the efficiency of operation by the PP system operators. Other memory modules, other than a database may be used

Third party payments are monitored, made and noted through the input/output I/O module 172. Payments to the content provider CP are also engaged and effected by I/O unit 172.

The payment processor system 160 operates in conjunction with third party A1 data store 180. In some situations, the third party data store 180 would upload the content to website server 162. In other times, the content would be downloaded to third party data store 180. Cnt shares may be transferred by hyperlinks to the content on web server 162 or from the web server 162 to third party data store 180. An additional third party data store A2, data store 181 is utilized as indicated by the I/O unit 172 operating in conjunction with the onboard data store. The Cnt may be published on multiple servers.

References to third party websites in the metric modules discussed earlier generally refer to sites A1 and A2.

A search engine 182 is engaged by the processor 164 and I/O unit 172. Search engine 182 could be Google™ or Bing™. The search engine searches multiple third party data stores 184 and provides information through I/O unit 162 to the processor and the payment sub-system and the search sub-system as described earlier in connection with the scoring metrics and modules.

FIG. 9 diagrammatically illustrates a distributed version of the system. In FIG. 9, the web server system 210 is generally separated from, but associated with, the payment processor system 220. Web system 210 includes web server 212 and I/O unit 218. The web server includes a processor 214 and a memory store 216. Payment processor 220 includes a processor unit 222 and a memory store 224 and a I/O unit 230. Processor units execute the program modules discussed earlier. A payment allocator 226 is a module operating within the processor 222 and with memory 224. The payment allocator 226 obtains input from revenue sources 228. These revenue sources are discussed earlier regarding revenue for ad fees, sponsored ad links, referral fees and user fees. Other revenue sources may be tied into the PP system.

Payment processor 220 operates in conjunction with a content database 234. Sometimes the Cnt is held in DB memory (or other memory) by the PP system. At other times, the PP system may contract out that Cnt memory store. The content provider—UPP database 232 also operates in conjunction with a payment processor system 220. Content may be provided directly to CP content store 234 by the CP or the CP may give a link to the PP system and the PP system may obtain the Cnt directly. Otherwise, the PP system may transfer links from DB store to the website server and server DB (server DB not shown). The CP may provide content provider biographic data to the web server system 210 from the PP system memory. The resumes are also used by the search modules to determine payment scores.

The operation of associated web server 212 is monitored by two units, a content performance tracker system 238 and a revenue fee monitor 242. Tracker system 238 utilizes an I/O unit 236 which operates in conjunction with I/O unit 218 of web server 210. Revenue monitor 242 includes an I/O unit 240 which operates in conjunction with the similar I/O unit in web server 210. Effectively, the performance tracker 238 monitors associated web server 212 and delivers information data back to I/O unit 230, of payment processor system 220. The processor in system 220 executes the module algorithms discussed above, gathers external and internal data, and calculates the allocated payments with the sub-systems. Web server 212 may have small programs on the uploaded content server module which monitor views and hits and other metric-listed data and capture viewer data as discussed above in connection with modules 410-620. The revenue fee monitor 242 monitors the fees associated with the uploaded content on web server 212. Systems 238 and 242 are distributed between 212 and 220 as determined by efficiency parameters. Data metrics are provided back to payment processor 220 as discussed above in connection with modules 410 to 620.

When payment is made by payment allocator 226 of payment processor 220, an instruction effecting payment is sent to bank system 246. Certain monies or allocations are paid to the content provider CP as discussed herein. Other monies are paid to the operator of web server system 212. Additional monies are paid to the payment processor system 220 as transaction fees for operating the system.

Abbreviations Table

| | |
|---|---|
| 3^{rd} Pty | Third party not under the control of the System Operator SysOp |
| A-sp | customer A speech, represented by digital signals, typically accepted by the CC |
| | comp. |
| ad | advertisement |
| Ad rev | advertising revenue |
| addr | address—typically an IP address, but may also include a mailing address for a |
| | registered user or registered CP Content Provider |
| Admin | Administrator |
| alt | alternate or optional (opt) path or step |
| API | application program interface |
| appln | application by a User, Visitor or Content Provider |
| ASP | application service provider—server on a network |
| AV | audio-visual Content Cnt |
| bd | board |
| Bus | Business |
| calc | calculate and re-calc is re-calculate |
| Cap | maximum CPM fees, on CPO fees |
| CCT | content, context and taxonomic as in CCT analysis |
| CCT analysis | Content Cnt subject, title, key words, descriptors, maybe unique text, sometimes |
| | combines with all comments on Cnt |
| CD-RW | compact disk drive with read/write feature for CD disk |
| chrg | credit card or debit card charge |
| Cnt | Content supplied by User or Content Provider CP, as an example, Cnt-DateCode |
| | refers to the specific uploaded/downloaded Cnt, a unique webpage or sement of a |
| | webpage with the specific Cnt |
| Cnt type | Audio visual AV, image, blog, audio, h-link (hyper-link), pdf, ppt (PowerPoint ™), |
| | Excel ™ spreadsheet, Q&A question and answer, maps, 3d models three |
| | dimensional models, avatars |
| Cnt quality | Cnt-Qual, high or low quality image or audio-visual AV such as an AV grainy image |
| | or video, high Qual AV format HD high definition, see Cnt-Qual and for textual |
| | materials Text-Qual |
| comm sess | communications session |
| comm | communications, typically telecommunications (telecomm) |
| comp | computer having internet enabled communications module |
| Cos. | companies |
| CP | Content Provider, the CP must be a registered reg'd User with a UPP |
| CP/UPP-User | sometimes, a module or an operational process applies equally to a Content |
| | Provider CP and a Registered User (a person who has not posted Content Cnt |
| | on the Sys site) |
| CP-Qual | initial CP-Qual value or factor assigned to the Content Provider CP, see also assigned |
| | initial UPP-User-Qual value which is the initial quality Qual factor applied to a |
| | Registered Reg'd User with a UPP; the Qual factor assigned to the UPP-User or the |
| | CP changes based upon dynamics on the Sys site. |
| CPC | cost per click, may be unitized by 1,000 clicks |
| CPI | cost per impression, an impression being a single view by a single viewer, who may |
| | be a registered User or a Content Provider CP, may be unitized by 1,000, CPM is 1k |
| | CPI, typically “1 CPI” is understood to be for 1,000 impressions/views |
| CPM | 1000 CPI |
| CPO | cost per order |
| CPU | central processing unit |
| cr.cd. | credit card or debit card transactions |
| credit/debit | credit card or debit card transactions |
| cust | Customer |
| DateCode | as in Cnt-DateCode—to identify a certain specific Content Cnt, an Cnt upload date- |
| | time code is noted |
| DB | database |
| disp | display, typically display a web page or display certain information |
| doc | document |
| drv | drive, e.g., computer hard drive |
| DS | data storage |
| e | encryption |
| e.g. | for example |
| em | email |
| emo | emotional module that senses voice signals or detects aggressive/passive textual |
| | materials and outputs an indication of the emotional state of the speaker |
| equip | equipment |
| esp | especially, or primarily an example |
| Fac | Facility |
| fav | favorites |
| G.P.S. | Geo positioning system and location (optionally time data) |
| Geo | geographic indicator data |
| Geo loc | geographic location of Content Provider CP and/or UPP-User |
| h-link | hyper link to a certain webpage or landing page |
| I/O | input/output |
| id | identify, a V-id is a temporary identifier of a Visitor to the Sys System website who |
| | either does not have a UPP or who has not been identified as being associated with |
| | a User's UPP |
| idx | index |
| ie or IE | Internet-enabled device, like a smart phone, tablet computer, computer, etc. |
| IP addr | internet protocol address of internet enabled device, may be the IP addr in the User- |
| | UPP |
| IVR | interactive voice response |
| loc | location |
| max'm | maximum |
| mbr | member |
| mem | memory |
| mess | message as in SMS or text message |
| min'n | minimum |
| mkting | marketing |
| money $ | money, without regard to type of currency, $ can be dollars, euros, etc. for example, |
| | CP-$-Total is the aggregate total all Content Cnt for all time posted by a CP; CP-$- |
| | CntDateCode-Total is the all time total for a specific Cnt |
| ntwk | |
| ntwk | network, sometimes a telecomm network, typically internet based network, a local |
| | area network LAN, or a social network such as FaceBook ™, etc. |
| obj | object, for example, a data object |
| opt | optional or alternative program or module |
| P/W | password |
| pg | page, typically a web page, may be a landing web page |
| pgm | program |
| ph | phone, namely an internet enabled phone, such as a smart phone |
| ph.no. | phone number |
| pmt | payment |
| pt. | point, as in jump point to another portion of the program |
| Pty | party, may be the CP or the UPP-User or a 3^{rd} Pty as in another Sys system providing |
| | data or information to the subject Sys |
| Q&A | question and answer, comment and follow-on responsive comment |
| Qual | Quality |
| Qual score | a scoring protocol to ascertain the relative quality of a User or a CP or Content Cnt |
| | relative to other Users. Cps or Cnts |
| Quan | quantity or amount, sometimes Quant |
| Quant | quantity or amount, sometimes Quan, V-quant is a quantity of something associated |
| | with a Visitor, maybe UPP-User-Quant, CP-Quant |
| Quant time | amount of time on Sys site |
| rcd | record or log-in data; sometimes also refers to a database record |
| re | regarding or relating to |
| recog | recognition, such as identifying a Visitor as a UPP-User or CP |
| reg'd | registered as in a Registered User or CP, sometimes Reg'd, sometimes used to refer |
| | to “the time at registration” in the User Personal Profile or UPP |
| reg'd IP residence | the IP address in the UPP-User DB |
| reg'd geo loc | the registered geographic data in the UPP |
| Reg'd CP | registered CP with a UPP |
| Reg'd Viewer | a User with a UPP, a UPP-User |
| Reg'd User | a User with a UPP, a UPP-User |
| rel | release |
| rem | reminder, such as a reminder email |
| resp | response |
| rev share | revenue share |
| rpt | report |
| Rqt | request, sometimes rqt or RQT |
| rt | real time, may include day and time stamp data |
| rvw | review |
| S-recog | speech recognition or decoding digital voice signals |
| sch | search |
| sec | security |
| sel | select |
| share | a protocol whereby someone links one Cnt to another website or web page. A share |
| | Quant for certain time windows is a quantity of shares over a predetermined time |
| | period or window, see social ntwk shares |
| smart ph | smart phone coupled to the internet |
| sms | text message or short message service |
| SR | search engine results from GOOGLE ™, BING ™, YAHOO ™ |
| SR Quant | the number of times in an internet search that a term or user name appears, for |
| | example, the SR Quant may be 20 hits in a total search result of the first 100 result |
| | pages or websites |
| SR rank | search engine results with a ranking number associated therewith, for example, the |
| | “rank 1 tier” is an internet search hit for a term or name in the first 10 search results |
| | reported by the search engine, e.g., Google ™, SR rank in search engine for ranking |
| | of Cnt |
| std | standard |
| stmt | statement |
| Svr | sever, as in web server |
| sys | computer system or computer network, maybe called Sys |
| SysOp | System Operator or a reference to the computer system owned or operated by a |
| | subject organization, esp., the System Sys operating the programs in the present |
| | invention. A 3^{rd} Party Sys is another computer system not within the computer |
| | network which carries out the present invention |
| t | time, e.g., UPP-t-Site-Total-Time is an aggregate time for all visits on specific |
| | website for a certain UPP-User; for Content Cnt: UPP-CntDateCode-Total-Time is |
| | total time on specific Cnt by a single UPP-User; for UPP-CntDateCode-Vdate-Time- |
| | Now: this is the total time for a specific visit (Vdate) on a Content Cnt page |
| | (CntDateCode) or location for a specific UPP-User. |
| t window | a predetermined period of time, sometimes a “window t”; t windows may be 24 hr t, |
| | a one-week t, a monthly t, or upon CP RQT request; time windows: CP-Ag- |
| | Twindow24 hr is the total time during the 24 hr time window that has some |
| | relationship with the Content Provider CP; CP-Ag-Twindow1 week and CP-Ag- |
| | Twindow1 Month refer to 1 week and 1 month windows or events or actions that |
| | occur at 1 week or 1 month |
| taxo | Taxonomic Analysis, sometimes Taxo categories |
| tbl | tablet computer |
| telecom | telecommunications system or network |
| temp | temporary event or upload |
| TTP | Trusted Third Party system |
| univ. | universal application or common application |
| Unreg' d User | a Visitor to the Sys website who either has nor registered with a UPP or a visitor who |
| | has not yet been associated with a UPP |
| upload/download | the transfer of content Cnt to the Sys System, the term upload or download |
| | depends upon the perspective of the observer |
| UPP IP addr. | IP address at Cnt upload or the IP address as listed in the User's UPP |
| UPP | User's Personal Profile, a UPP creates a registered User, e.g., a Visitor completes a |
| | UPP prior to uploading Content Cnt |
| UPP-User Qual | quality score of a UPP-User |
| UPP-User | a registered User with a UPP |
| URL | Uniform Resource Locator, x pointer, or other network locator |
| user-visitors | Visitors at the Sys website who have not registered with UPP |
| V-id | Viewer UPP data if any. If UPP found, assign Viewer Qual score based upon |
| | CP/UPP-User data |
| V-id-Grp | Viewer meets a predetermined user-visitor group profile |
| V-id-Grp-Qual | the Quality of a group, e.g., any posting from the Rolling Stones magazine |
| V-id-Refer | Referral source for Viewer |
| V-id-t-Site-Total-Time | aggregate t on Sys site for a Visitor assigned a temporary V-id |
| V-id-V-Qual | quality score for a V-id |
| Viewer velocity | number of Visitors on Cnt during a predefined time period, e.g., visitors per |
| | hour on Cnt |
| Viewer Quan | quantity of number Visitors on a Cnt |
| Viewer Qual | quality of Visitors on Cnt |
| w/in | within |
| w/out | without |
| w/ | with |
| wrt | with respect to |

### Description of Typical System Features

The CP payment system and method is typically deployed over a distributed computer system, namely, a system with several processor and memory units. However, the payment system could be integrated in to a singular computer system with a web server module, a payment processing module and a memory with the several databases discusses herein. Also the content could be stored in any convenient memory system or module rather than a database, at internal or external locations as discussed herein. Memory systems for content are well known by persons of ordinary skill in the art.

The present invention relates to data processes via computer systems, over the Internet and/or on a computer network (LAN or WAN), and computer programs, computer modules and information processing systems which accomplish these tracking services and payment allocations.

It is important to know that the embodiments illustrated herein and described herein below are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art. Further, the program, or components or modules thereof, may be downloaded from the Internet of otherwise through a computer network.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits.

The claims appended hereto are meant to cover modifications and changes within the scope and spirit of the present invention.

What is claimed is:

1. A method of paying a content provider who supplies online content to a web-based server coupled to the internet, said web-based server being operatively coupled to a payment processor computer and memory data storage, the method comprising:
registering users by obtaining a user's profile data and storing said user profile data in said memory;
obtaining content in digital from uploaded to said web-based server from said registered user who is then defined as a content provider for the uploaded content;
said web-based server publishing said uploaded content on the internet;
monitoring one or the other or both views and acclamations for said uploaded content;
monetizing said uploaded content related or unrelated to one or more revenue source fees from the group of revenue sources including advertising fees, sponsored ad fees, referral fees and user fees which generate monetary revenue;
allocating, to said content provider, all or a portion of said revenue source fees based upon two or more payment parameters from the group of payment parameters including first, second, third and fourth payment parameters, wherein
(a) said first payment parameter is based upon content provider centric actions or characteristics;
(b) said second payment parameter is based upon content centric actions or characteristics;
(c) said third payment parameter is based upon content performance centric characteristics;
(d) said fourth payment parameter is based upon viewer centric actions or characteristics; and
paying said content provider for said uploaded content based upon the allocation of said revenue source fees.

2. The method of paying a content provider as claimed in claim 1 wherein said first, second, third and fourth payment parameters are respectively determined in conjunction with a corresponding temporal period or event.

3. The method of paying a content provider as claimed in claim 2 wherein the corresponding temporal period or event is based upon one or more of a pre-content upload event, a content upload event, and a predetermined time period after the content upload event.

4. The method of paying a content provider as claimed in claim 1 wherein said first, second, third and fourth payment parameters are respectively determined in conjunction with a corresponding temporal period or event, said first payment parameter determined when uploaded content is published; said second payment parameter determined either before or when the uploaded content is published; said third payment parameter determined after the uploaded content is published and for predetermined time periods after publication; and said fourth payment parameter determined after the uploaded content is published and for predetermined time periods after publication.

5. The method of paying a content provider as claimed in claim 1 wherein said first payment parameter is determined when the uploaded content is published based upon one or more of:
one or more content uploading metrics based upon content provider acts;
geographic location data associated with said content provider or said uploaded content;
one or more financial metrics based upon said uploaded content or other uploaded content provided by said content provider to said web-based server;
one or more fame metrics for said content provider; and
one or more content provider action metrics accounting for actions in connection with said web-based server.

6. The method of paying a content provider as claimed in claim 1 wherein said second payment parameter is determined before or when the uploaded content is published based upon one or more of:
a quality and a quantity of said uploaded content;
an acclaim metric for said uploaded content;
a topic and content relevancy metric for said uploaded content;
a temporal relevancy metric for said uploaded content; and,
a geographic relevancy metric for said uploaded content.

7. The method of paying a content provider as claimed in claim 1 wherein said third payment parameter is determined after the uploaded content is published and is based upon performance of said uploaded content over predetermined time periods, and wherein the performance metrics account for internet views of the uploaded content.

8. The method of paying a content provider as claimed in claim 1 wherein said fourth payment parameter is determined after the uploaded content is published and is based upon one or more of:
one or more viewer identity metrics for viewers of the uploaded content;
one or more temporal viewer metrics on the uploaded content; and,
return viewer metrics for the uploaded content.

9. The method of paying a content provider as claimed in claim 1 wherein the monitoring of views and acclamations for said uploaded content includes one or more monitoring of:
posted comments by others;
approval and disapproval indicia;
links to the uploaded content;
links from the uploaded content; and
social network postings and processing.

10. The method of paying a content provider as claimed in claim 1 wherein paying said content provider said allocation of said revenue fees includes effecting the payment of money to said content provider through a banking system.

11. The method of paying a content provider as claimed in claim 1 wherein
said first, second, third and fourth payment parameters are respectively determined in conjunction with a corresponding temporal period or event;
said first payment parameter is determined based upon: content uploading metrics, content provider acts, geographic location data associated with said content provider, geographic location data associated with said uploaded content, financial metrics associated with said uploaded content, financial metrics associated with other uploaded content provided by said content provider to said web-based server, fame metrics for said content provider, and content provider action metrics accounting for actions in connection with said web-based server;
said second payment parameter is determined based upon: a quality of said uploaded content, a quantity of said uploaded content, acclaim metrics for said uploaded content, topic and content relevancy metrics for said uploaded content, temporal relevancy metrics for said uploaded content, and, geographic relevancy metrics for said uploaded content;
said third payment parameter is determined based upon performance metrics accounting for internet views of said uploaded content over predetermined time periods; and,
said fourth payment parameter is determined based upon: viewer identity metrics for viewers of the uploaded content, temporal viewer metrics on the uploaded content, and, return viewer metrics for the uploaded content.

12. The method of paying a content provider as claimed in claim 11 wherein paying said content provider said allocation of said revenue fees includes effecting the payment of money to said content provider through a banking system.

13. The method of paying a content provider as claimed in claim 12 wherein the monitoring of views and acclamations for said uploaded content includes one or more monitoring of:
posted comments by others;
approval and disapproval indicia;
links to the uploaded content;
links from the uploaded content; and
social network postings and processing.

14. The method of paying a content provider as claimed in claim 7 wherein said third payment parameter accounting for internet views of the uploaded content includes views and acclamations for said uploaded content and one or more of: posted comments by viewers; approval and disapproval indicia by viewers; links to the uploaded content by viewers; links from the uploaded content by viewers; and social network postings by viewers and processing by social network systems.

15. A method of paying a content provider who supplies online content to a web-based server coupled to the internet, said web-based server being operatively coupled to a payment processor computer and memory data storage, the method comprising:
registering users by obtaining a user's profile data and storing said user profile data in said memory;
obtaining content in digital from uploaded to said web-based server from said registered user who is then defined as a content provider for the uploaded content;
said web-based server publishing said uploaded content on the internet;
monitoring one or the other or both views and acclamations for said uploaded content;
monetizing said uploaded content related or unrelated to one or more revenue source fees from the group of revenue sources including advertising fees, sponsored ad fees, referral fees and user fees which generate monetary revenue;
allocating, to said content provider, all or a portion of said revenue source fees based upon one or more payment parameters from the group of payment parameters including first, second, and third payment parameters, wherein
(a) said first payment parameter is based upon content provider centric actions or characteristics;
(b) said second payment parameter is based upon content centric actions or characteristics;
(c) said third payment parameter is based upon viewer centric actions or characteristics; and
paying said content provider for said uploaded content based upon the allocation of said revenue source fees.

16. The method of paying a content provider as claimed in claim 15 wherein said first, second, and third payment parameters are respectively determined in conjunction with a corresponding temporal period or event.

17. The method of paying a content provider as claimed in claim 16 wherein the corresponding temporal period or event is based upon one or more of a pre-content upload event, a content upload event, and a predetermined time period after the content upload event.

18. The method of paying a content provider as claimed in claim 15 wherein said first, second, and third payment parameters are respectively determined in conjunction with a corresponding temporal period or event, said first payment parameter determined when uploaded content is published; said second payment parameter determined either before or when the uploaded content is published; said third payment parameter determined after the uploaded content is published and for predetermined time periods after publication.

19. The method of paying a content provider as claimed in claim 15 wherein said first payment parameter is determined when the uploaded content is published based upon one or more of:
one or more content uploading metrics based upon content provider acts;
geographic location data associated with said content provider or said uploaded content;
one or more financial metrics based upon said uploaded content or other uploaded content provided by said content provider to said web-based server;
one or more fame metrics for said content provider; and
one or more content provider action metrics accounting for actions in connection with said web-based server.

20. The method of paying a content provider as claimed in claim 15 wherein said second payment parameter is determined before or when the uploaded content is published based upon one or more of:
a quality and a quantity of said uploaded content;
an acclaim metric for said uploaded content;
a topic and content relevancy metric for said uploaded content;
a temporal relevancy metric for said uploaded content; and,
a geographic relevancy metric for said uploaded content.

21. The method of paying a content provider as claimed in claim 15 wherein said third payment parameter is determined after the uploaded content is published and is based upon one or more of:
one or more viewer identity metrics for viewers of the uploaded content;
one or more temporal viewer metrics on the uploaded content; and,
return viewer metrics for the uploaded content.

22. The method of paying a content provider as claimed in claim 15 wherein the monitoring of one or both of the views and acclamations for said uploaded content includes one or more monitoring of:
posted comments by others;
approval and disapproval indicia;
links to the uploaded content;
links from the uploaded content; and
social network postings and processing.

23. The method of paying a content provider as claimed in claim 15 wherein paying said content provider said allocation of said revenue fees includes effecting the payment of money to said content provider through a banking system.

24. The method of paying a content provider as claimed in claim 15 wherein
said first, second, and third payment parameters are respectively determined in conjunction with a corresponding temporal period or event;
said first payment parameter is determined based upon: content uploading metrics, content provider acts, geographic location data associated with said content provider, geographic location data associated with said uploaded content, financial metrics associated with said uploaded content, financial metrics associated with other uploaded content provided by said content provider to said web-based server, fame metrics for said content provider, and content provider action metrics accounting for actions in connection with said web-based server;
said second payment parameter is determined based upon: a quality of said uploaded content, a quantity of said uploaded content, acclaim metrics for said uploaded content, topic and content relevancy metrics for said uploaded content, temporal relevancy metrics for said uploaded content, and, geographic relevancy metrics for said uploaded content;
said third payment parameter is determined based upon: viewer identity metrics for viewers of the uploaded content, temporal viewer metrics on the uploaded content, and, return viewer metrics for the uploaded content.

25. The method of paying a content provider as claimed in claim 24 wherein paying said content provider said allocation of said revenue fees includes effecting the payment of money to said content provider through a banking system.

26. The method of paying a content provider as claimed in claim 25 wherein the monitoring of one or more of the views and acclamations for said uploaded content includes one or more monitoring of:
posted comments by others;
approval and disapproval indicia;
links to the uploaded content;
links from the uploaded content; and
social network postings and processing.

27. A payment processing system, having a payment processor and a memory data storage, for paying a content provider who supplies online content to a web-based server, said payment processing system and said web-based server coupled to the internet, said web-based server being operatively coupled to a said payment processor and memory, the payment processing system comprising:
a compiler for registering users by obtaining a user's profile data and storing the same in said memory;
an uploader for delivering content in digital form to said web-based server, said content being associated with said registered user who is then a content provider for said uploaded content;
a tracking module monitoring one or more of views and acclamations for said uploaded content published on said web-based server;
a revenue tracking module accounting for one or more revenue source fees from the group of revenue sources including advertising fees, sponsored ad fees, referral fees and user fees which generate monetary revenue for said web-based server;
means for determining an allocation, for said content provider, from said revenue source fees based upon two or more payment parameters from the group of payment parameters including first, second, third and fourth payment parameters, wherein
(a) said first payment parameter is based upon content provider centric actions or characteristics;
(b) said second payment parameter is based upon content centric actions or characteristics;
(c) said third payment parameter is based upon content performance centric characteristics;
(d) said fourth payment parameter is based upon viewer centric actions or characteristics; and
a payment module paying said content provider for said uploaded content based upon the allocation of said revenue source fees, said payment module coupled to said tracking module, said revenue tracking module and the means for allocating said revenue source fees, said payment module effecting the transfer of money for said uploaded content to said content provider.

28. The payment processing system as claimed in claim 27 wherein said first payment parameter is determined when the uploaded content is published and is based upon one or more of:
a content uploading metric based upon content provider acts;
geographic location data associated with said content provider or said uploaded content;
a financial metric based upon said uploaded content or other uploaded content associated with said content provider and published on said web-based server;
a fame metric for said content provider; and
a content provider action metric accounting for actions in connection with said web-based server.

29. The payment processing system as claimed in claim 27 wherein said second payment parameter is determined before or when the uploaded content is published and is based upon one or more of:
a quality and a quantity of said uploaded content;
an acclaim metric for said uploaded content;
a topic and content relevancy metric for said uploaded content;
a temporal relevancy metric for said uploaded content; and,
a geographic relevancy metric for said uploaded content.

30. The payment processing system as claimed in claim 27 wherein said third payment parameter is determined after the uploaded content is published and is based upon one or more of:
a viewer identity metric for viewers of the uploaded content;
a temporal viewer metric on the uploaded content; and,
a return viewer metric for the uploaded content.

31. The payment processing system as claimed in claim 27 wherein said tracking module for monitoring one or more of the views and acclamations for said uploaded content includes monitoring of one of more of: posted comments by others; approval and disapproval indicia; links to the uploaded content; links from the uploaded content; and social network postings and processing.

32. A payment processing system with a payment processor, a memory data storage, an internet or other electronic communications module which pays a content provider who supplies online content to a web-based server for the online content, the payment processing system comprising:
a compiler for registering users by obtaining a user's profile data and storing the same in said memory;
an uploader for delivering content in digital form to said web-based server and wherein said compiler associates the uploaded content with said registered user and said registered user being a content provider with respect to said uploaded content;
a tracking module, operatively coupled to said payment processor, for monitoring one or more of views and acclamations for said uploaded content published on said web-based server;
a revenue tracking module, operatively coupled to said payment processor, accounting for one or more revenue source fees from the group of revenue sources including advertising fees, sponsored ad fees, referral fees and user fees which generate monetary revenue from said web-based server;
said payment processor having means for determining an allocation, for said content provider, from said revenue source fees based upon two or more payment parameters from the group of payment parameters including first, second, third and fourth payment parameters, wherein
(a) said first payment parameter is based upon content provider centric actions or characteristics;
(b) said second payment parameter is based upon content centric actions or characteristics;
(c) said third payment parameter is based upon content performance centric characteristics;
(d) said fourth payment parameter is based upon viewer centric actions or characteristics; and
a payment module paying said content provider for said uploaded content based upon the allocation of said revenue source fees, said payment module coupled to said payment processor, said tracking module, said revenue tracking module and the means for allocating said revenue source fees, said payment module effecting the transfer of money for said uploaded content to said content provider.

33. A payment processing system as claimed in claim 32 wherein said means for determining the content provider's allocation is coupled to:
said compiler and uploader for the processing of the first payment parameter,
said compiler and uploader for the processing of the second payment parameter,
the views and acclamations tracking module for the processing of the third payment parameter,
said views and acclamations tracking module for the processing of the fourth payment parameter,

34. The payment processing system as claimed in claim 32 wherein said first payment parameter is determined when the uploaded content is published based upon one or more of:
a content uploading metric based upon content provider acts from said compiler;
geographic location data associated with said content provider or said uploaded content from either said compiler or said uploader;
a financial metric based upon said uploaded content or other uploaded content associated with said content provider from either said compiler or said uploader;
a fame metric for said content provider form said compiler; and
a content provider action metric accounting for actions in connection with said web-based server form said compiler.

35. The payment processing system as claimed in claim 32 wherein said second payment parameter is determined before or when the uploaded content is published based upon one or more of:
a quality and a quantity of said uploaded content from said uploader;
an acclaim metric for said uploaded content from either said uploader or said tracking module;
a topic and content relevancy metric for said uploaded content from either said uploader or said tracking module;
a temporal relevancy metric for said uploaded content from either said uploader or said tracking module; and,
a geographic relevancy metric for said uploaded content from either said uploader or said tracking module.

36. The payment processing system as claimed in claim 32 wherein said third payment parameter is determined after the uploaded content is published and is based upon performance of said uploaded content over predetermined time periods, and wherein the performance metrics account for internet views of the uploaded content.

37. The payment processing system as claimed in claim 32 wherein said fourth payment parameter is determined after the uploaded content is published and is based upon one or more of:
a viewer identity metric for viewers of the uploaded content from said tracking module;
a temporal viewer metric on the uploaded content from said tracking module; and,
a return viewer metric for the uploaded content from said tracking module.

38. The payment processing system as claimed in claim 32 wherein said tracking module for monitoring views and acclamations for said uploaded content includes monitoring of one of more of: posted comments by others; approval and disapproval indicia; links to the uploaded content; links from the uploaded content; and social network postings and processing.

39. A payment processing system, having a payment processor and a memory data storage, for paying a content provider who supplies online content to a web-based server, said payment processing system and said web-based server coupled to the internet, said web-based server being operatively coupled to a said payment processor and memory, the payment processing system comprising:
a compiler for registering users by obtaining a user's profile data and storing the same in said memory;
an uploader for delivering content in digital form to said web-based server, said content being associated with said registered user who is then a content provider for said uploaded content;
a tracking module monitoring one or more of views and acclamations for said uploaded content published on said web-based server;
a revenue tracking module accounting for one or more revenue source fees from the group of revenue sources including advertising fees, sponsored ad fees, referral fees and user fees which generate monetary revenue for said web-based server;
means for determining an allocation, for said content provider, from said revenue source fees based upon one or more payment parameters from the group of payment parameters including first, second, and third payment parameters, wherein
(a) said first payment parameter is based upon content provider centric actions or characteristics;
(b) said second payment parameter is based upon content centric actions or characteristics;
(c) said third payment parameter is based upon viewer centric actions or characteristics; and
a payment module paying said content provider for said uploaded content based upon the allocation of said revenue source fees, said payment module coupled to said tracking module, said revenue tracking module and the means for allocating said revenue source fees, said payment module effecting the transfer of money for said uploaded content to said content provider.
